(19) United States
(12) Patent Application Publication
(10) Pub. No.: US 2022/0201320 A1
(43) Pub. Date: Jun. 23, 2022

(54) VIDEO ANALYTICS USING SCALABLE VIDEO CODING

(71) Applicants: Passant V. Karunaratne, Chandler, AZ (US); Stewart N. Taylor, Los Altos Hills, CA (US); Ryan D. Metcalfe, Fairport, NY (US)

(72) Inventors: Passant V. Karunaratne, Chandler, AZ (US); Stewart N. Taylor, Los Altos Hills, CA (US); Ryan D. Metcalfe, Fairport, NY (US)

(21) Appl. No.: 17/692,817

(22) Filed: Mar. 11, 2022

Related U.S. Application Data
(60) Provisional application No. 63/159,955, filed on Mar. 11, 2021.

(51) Int. Cl. H04N 19/29; G06V 10/82; G06T 3/40; H04N 19/59; H04N 19/187; H04N 19/34; G06V 20/40

(52) U.S. Cl. CPC H04N 19/29; G06V 10/82; G06T 3/40; G06V 20/41; H04N 19/187; H04N 19/34; H04N 19/59

(57) ABSTRACT

In one embodiment, a computing device includes processing circuitry and interface circuitry. The processing circuitry receives an encoded video stream via the interface circuitry, which contains video encoded within multiple layers corresponding to different video resolutions, including a base layer and one or more enhancement layers. The base layer encodes the video at a base resolution and the one or more enhancement layers encode the video at one or more enhanced resolutions higher than the base resolution. The processing circuitry extracts the base layer from the encoded video stream and decodes the video at the base resolution from the base layer. The processing circuitry then detects content in the video at the base resolution and generates metadata indicating the content detected in the video.

### CROSS-REFERENCE TO RELATED APPLICATION

This patent application claims the benefit of the filing date of U.S. Provisional Patent Application Ser. No. 63/159,955, filed on Mar. 11, 2021, and entitled “VIDEO ANALYTICS USING SCALABLE VIDEO CODING,” the contents of which are hereby expressly incorporated by reference.

### FIELD OF THE SPECIFICATION

This disclosure relates in general to the field of video processing, and more particularly, though not exclusively, to video analytics using scalable video coding.

### BACKGROUND

Video analytics use cases are increasingly being deployed on edge computing systems that use special-purpose accelerators to perform compute-intensive video processing tasks. Due to power and cost constraints for deployments at the edge, however, these accelerators often have limited compute resources, as well as limited bandwidth for data transmissions from the host processor. This often results in video decoding and/or bandwidth bottlenecks in an edge system, which may limit the overall throughput of the system.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an example computing environment for performing video analytics using scalable video coding in accordance with certain embodiments.

FIGS. 2A-B illustrate an example embodiment of a video analytics system that leverages scalable video coding.

FIG. 3 illustrates an example processing pipeline for a video analytics accelerator that leverages scalable video coding.

FIG. 4 illustrates a flowchart for performing video analytics on a scalable coded video stream in accordance with certain embodiments.

FIG. 5 illustrates an example embodiment of a computing system for performing video analytics.

FIG. 6 illustrates an overview of an edge cloud configuration for edge computing.

FIG. 7 illustrates operational layers among endpoints, an edge cloud, and cloud computing environments.

FIG. 8 illustrates an example approach for networking and services in an edge computing system.

FIG. 9 illustrates a domain topology for respective internet-of-things (IoT) networks coupled through links to respective gateways, according to an example.

FIG. 10 illustrates a cloud computing network in communication with a mesh network of IoT devices operating as a fog device at the Edge of the cloud computing network, according to an example.

FIG. 11 illustrates a drawing of a cloud computing network, or cloud, in communication with a number of Internet of Things (IoT) devices, according to an example.

FIG. 12 illustrates a block diagram for an example IoT processing system architecture upon which any one or more of the techniques (e.g., operations, processes, methods, and methodologies) discussed herein may be performed, according to an example.

FIG. 13 illustrates an overview of layers of distributed compute deployed among an Edge computing system, according to an example.

FIG. 14A provides an overview of example components for compute deployed at a compute node in an edge computing system.

FIG. 14B provides a further overview of example components within a computing device in an edge computing system.

FIG. 15 illustrates an example software distribution platform.

### EMBODIMENTS OF THE DISCLOSURE

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### Video Analytics Using Scalable Video Coding

Internet-of-Things (IoT) applications that require low latency and/or high bandwidth have benefited from the edge compute model and the availability of application-specific hardware to accelerate specific compute tasks, such as video analytics using deep-learning-based inference. However, due to power and cost constraints for deployments at the edge, these accelerators often have limited compute resources compared to more traditional forms of edge and cloud computing, along with bandwidth limitations for data transmissions over the interconnect between the host system and the accelerators. This results in throughput limitations for the edge system, potentially based on a single rate-determining factor, among the video processing and inference compute components and/or the communication bandwidth to an accelerator.

There are currently no solutions for video analytics use cases that efficiently address both the video decode compute limitations on the accelerator hardware and the bandwidth limitations between the host processor and the accelerator. For example, if the video decode is performed on an accelerator of an edge system, a video decode compute bottleneck may result due to the demanding compute requirements for decoding high resolution video. Alternatively, if the video decode is performed on the host processor of an edge system (e.g., primarily due to the lack of video decode capability on the accelerator), the video decode compute bottleneck may be eliminated on the accelerator, but a bandwidth bottleneck may result due to transmission of the decoded video data from the host processor to the accelerator.

For example, when only the deep-learning-based inference components of the video analytics pipeline are implemented on the accelerator, the host processor is encumbered with performing all video decode and post-processing operations in the pipeline prior to inference, possibly in a less resource-efficient manner. This drastically increases the computational load on the host processor, which may result in a video decode processing bottleneck and/or encroach on the computational headroom allocated for other functionalities and applications on the host processor. This approach also involves the inefficient transfer of decoded video pixel data over the communication interconnect from the host processor to the accelerator, which introduces a more stringent communication bandwidth bottleneck in the pipeline, thus limiting the overall throughput of the system.

Accordingly, this disclosure presents a solution that leverages video codec scalability approaches to (a) reduce the communication bandwidth required between the host processor and accelerator of an edge system, and (b) reduce the video decode computational complexity requirement at the accelerator. For example, reduction in the communication bandwidth and decode computational complexity is achieved using multi-layer video coding techniques, such as the base layer and scalability provisions of various prevalent and emerging video codecs (e.g., H.264 Advance Video Coding (AVC), H.265 High Efficiency Video Coding (HEVC), AOMedia Video 1 (AV1), VP9, MPEG-5 Part 2 Low-Complexity Enhancement Video Coding).

In some embodiments, for example, increased throughput is achieved on video analytics accelerators by minimizing the video decode compute load on the accelerator hardware using the spatial scalability features of mainstream and emergent video codecs. For example, the lowest-resolution base layer may be extracted from an incoming scalable video stream, and the base layer may then be provided to the video analytics accelerator for further decoding and processing. In this manner, the amount of data that must be decoded on the accelerator is minimized, and the inference components of the video analytics pipeline are able to operate at the native video resolution of the neural network, which is typically a lower resolution than the native or full resolution of the original video stream. This results in increased video analytics throughput and higher stream processing density on video analytics accelerators.

The improvement in throughput achieved by the described solution is shown below in Table 1, while the improvement in channel or stream density (e.g., the number of streams processed simultaneously) is shown below in Table 2. In particular, the improvement in video analytics throughput and stream density is shown for an original video stream at various resolutions (e.g., Ultra-High-Definition (UHD), Full HD, Standard HD, and Video Graphics Array (VGA) resolution) versus a spatially scalable video stream with a base layer at various lower resolutions.

This solution enables (a) higher throughput and/or (b) higher channel/stream density to be achieved by a video analytics accelerator when the source of the stream is aware of the video analytics processing to be performed and thus produces a scalable video bitstream (e.g., utilizing the spatial scalability extensions of the H.264 and H.265 video codecs and/or the MPEG-5 LC-EVC codec) that can be processed more efficiently by the accelerator. In this manner, the performance-per-Watt, performance-per-cost, and overall throughput performance of the video analytics accelerator is improved.

As an example, for a video analytics system that receives UHD resolution video streams as input, this solution can improve throughput by a factor of up to 28 and/or increase the number of channels (streams) serviced simultaneously by a single video analytics accelerator by a factor of over 30 (e.g., by performing video decoding and analytics on a base layer whose resolution is equal to the native input resolution of the neural network rather than on the original video stream at its native resolution).

Even for a video source with a lower native video resolution, such as standard HD (1280×720), the described solution can improve the throughput or stream density of the accelerator (or some balance of both) by 2.5 times.

TABLE 1
Improvement in video analytics throughput for lower-resolution
base layers versus native-resolution video streams

| | | Improvement in Throughput at Various | | | |
|---|---|---|---|---|---|
| | Analytics | Base Layer Resolutions | | | |
| | Throughput at | | | | 416 × 416 |
| Native Video | Native Resolution | | | | (Inference |
| Resolution | (Frames Per Second) | 1920 × 1080 | 1280 × 720 | 640 × 480 | Resolution) |
| UHD | 108.50 | 4.5× | 10.2× | 25.6× | 27.7× |
| (3840 × 2160) | | | | | |
| Full HD | 528.77 | | 2.3× | 5.7× | 7.2× |
| (1920 × 1080) | | | | | |
| Standard HD | 1158.11 | | | 2.5× | 3.1× |
| (1280 × 720) | | | | | |
| VGA | 2870.19 | | | | 1.4× |
| (640 × 480) | | | | | |

TABLE 2
Improvement in video analytics stream density (no. of streams processed
simultaneously) for lower-resolution base layers versus native-resolution video streams

| | | Improvement in Stream Density at Various | | | |
|---|---|---|---|---|---|
| | Analytics Stream | Base Layer Resolutions | | | |
| | Density at Native | | | | 416 × 416 |
| Native Video | Resolution/30 fps | | | | (Inference |
| Resolution | (# of Video Streams) | 1920 × 1080 | 1280 × 720 | 640 × 480 | Resolution) |
| UHD | 3 | 5.0× | 11.3× | 28.7× | 32.0× |
| (3840 × 2160) | | | | | |
| Full HD | 17 | | 2.3× | 5.7× | 7.4× |
| (1920 × 1080) | | | | | |
| Standard HD | 38 | | | 2.5× | 3.2× |
| (1280 × 720) | | | | | |
| VGA | 95 | | | | 1.4× |
| (640 × 480) | | | | | |

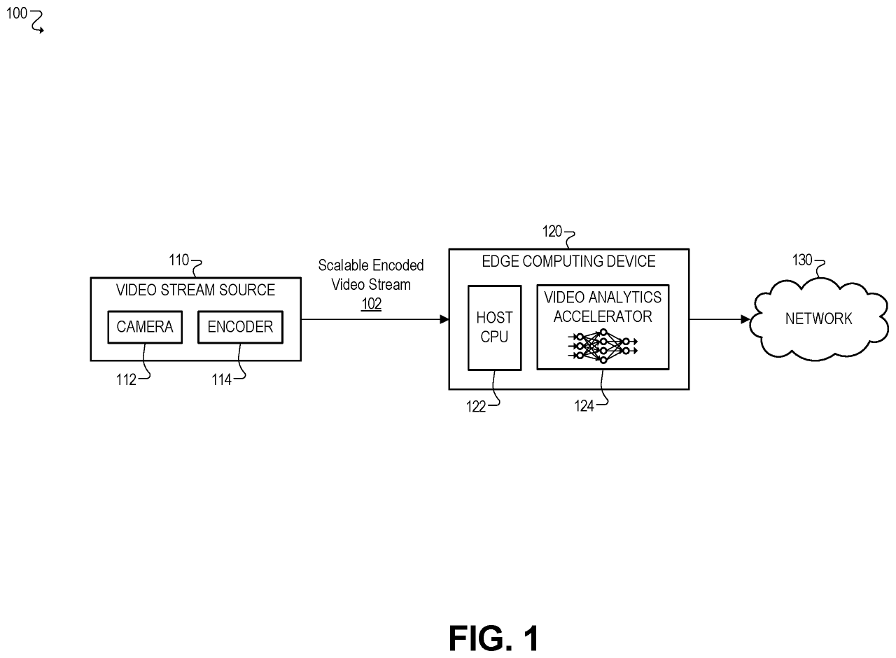

FIG. 1 illustrates an example computing environment 100 for performing video analytics using scalable video coding in accordance with certain embodiments. In the illustrated example, computing environment 100 includes a video stream source 110 with a camera 112 and a hardware video encoder 114, an edge computing device 120 with a host central processing unit (CPU) 122 and a video analytics accelerator 124, and a communication network 130, as described further below.

Traditional video analytics accelerators rely on a host system to receive video streams from their original sources and then channel the streams in their entirety to the accelerator hardware for analysis in their native form. As a result, these streams must be decoded at their native/full resolution by the accelerator and then subsequently scaled and/or cropped to the expected input dimensions of the neural network for the inference stage.

In the illustrated embodiment, however, the video stream source 110 leverages scalable video coding (e.g., the spatial scalability extensions of prevailing and emerging video codec standards such as H.264, H.265, AOMedia Video 1 (AV1), VP9, and/or MPEG-5 LC-EVC) to generate and encode the video streams 102 on which video analytics are to be performed. These scalable encoded video streams 102 are then provided to an edge computing device 120, where a host CPU 122 parses the received video streams and extracts the base layer(s) of the scalable streams, which the host CPU 122 then supplies to the video analytics accelerator 124 for processing.

The video analytics accelerator 124 utilizes the base layer of the incoming video stream(s) 102 as input to the video analytics pipeline, where the base layer is decoded using the onboard video decode acceleration hardware. The decoded frames are then resized or further scaled down to the expected resolution of the neural network (if necessary) and then processed per the subsequent steps of the video analytics pipeline implemented on the accelerator.

In various embodiments, for example, the described solution may utilize the following spatial scalability provisions provided by current and emergent video codecs:
(i) Scalable Video Coding (SVC) as defined by the Annex G extension of the H.264/MPEG-4 AVC video compression standard;
(ii) Scalable High Efficiency Video Coding (SHVC) as defined by the Annex H extension of the H.265/MPEG-H Part 2 (HEVC) video compression standard; and/or
(iii) MPEG-5 Part 2 Low Complexity Enhancement Video Coding video compression standard.

The solution can also be implemented using any other current or future video codec or video coding standard that supports spatial scalability of video content.

Moreover, in various embodiments, the host processor 122 on the edge computing device 120 may be implemented using any general-purpose processor or CPU (e.g., an Intel, AMD, and/or ARM processor) and/or other suitable processing hardware. Similarly, the video analytics accelerator 124 on the edge computing device 120 may be implemented using any special-purpose processor, accelerator, or graphics processing unit (GPU) for performing video processing tasks (e.g., Intel Movidius Vision Processing Units (VPUs), Intel GPUs, nVidia GPUs and video accelerators, AMD GPUs and video accelerators).

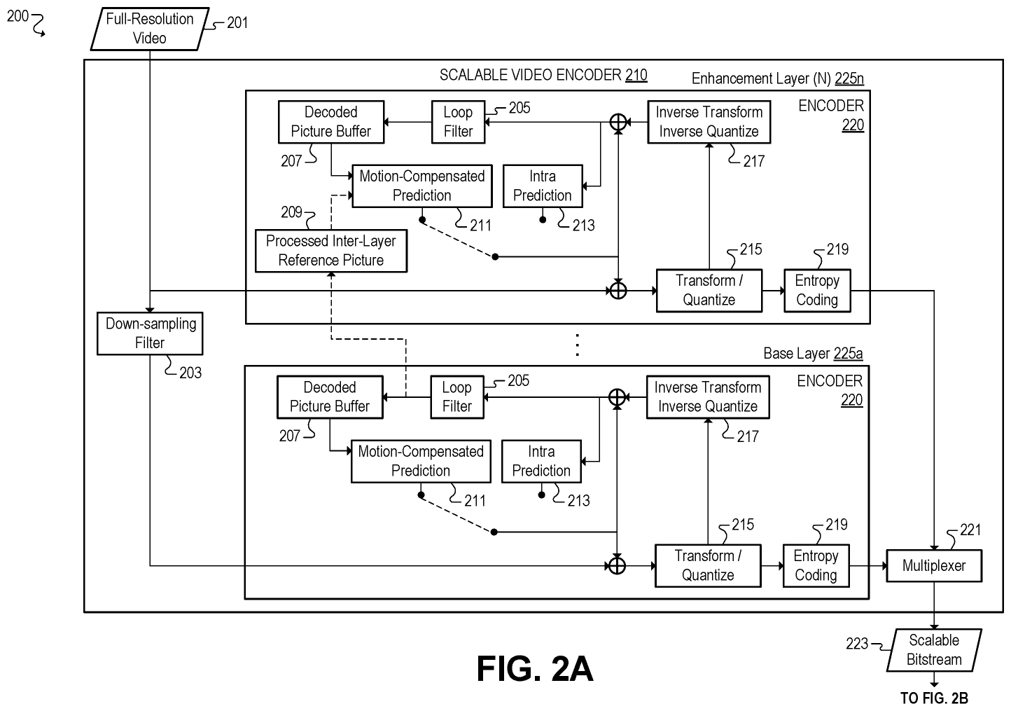

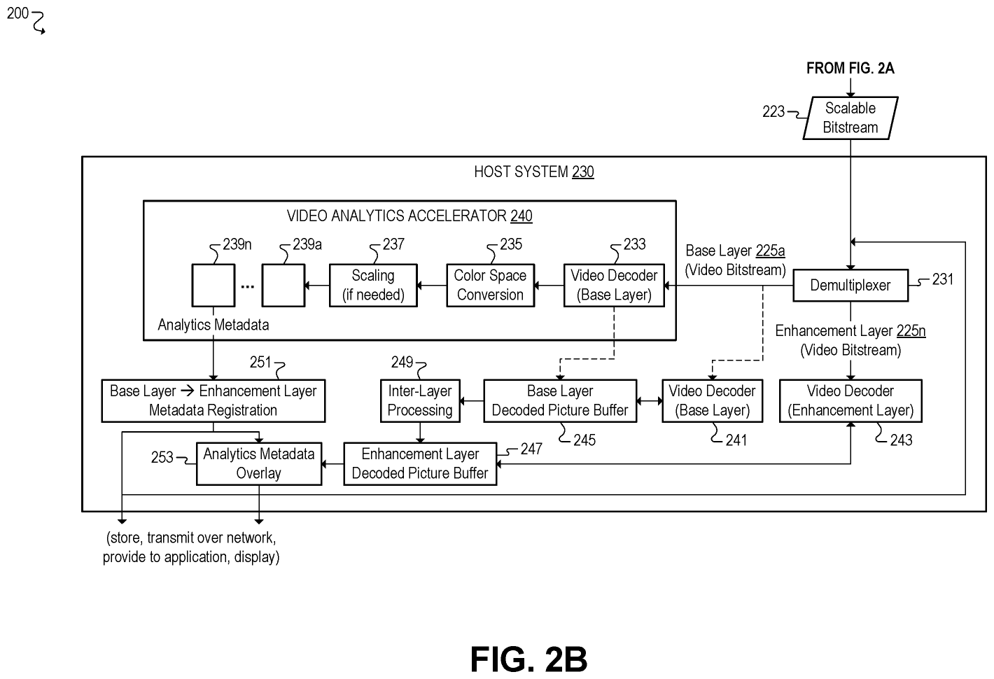

FIGS. 2A-B illustrate an example embodiment of a video analytics system 200 that leverages scalable video coding. In particular, FIG. 2A illustrates a scalable video encoder 210 that encodes a video 201 into a scalable video bitstream 223, and FIG. 2B illustrates a host computing system 230 that uses a video analytics accelerator 240 to perform video analytics on the base layer of the scalable video bitstream 223.

The functional blocks of the solution and underlying algorithm are shown for an example implementation on an edge system, which utilizes hardware acceleration and scalable video coding to accelerate video analytics workloads and optimize video analytics throughput at the edge.

In the illustrated embodiment, an instantiation of a scalable video encoder 210 is used to encode a full-resolution video 201 into a scalable video bitstream 223, which contains the video 201 encoded at multiple resolutions within multiple layers 225a-n. In various embodiments, for example, the scalable video encoder 210 may be used at a source video generating device (e.g., camera, digital video recorder, or any other video capture device) or any other video source (e.g., video repository, content distribution server). Moreover, while the scalable video encoder 210 most closely resembles a potential implementation of the H.265 Scalable High Efficiency Video Coding standard, it should be appreciated that the scalable video bitstream 223 may be produced using any video codec with scalable or layered video coding capabilities, including, but not limited to, H.264, H.265, AV1, VP9, MPEG-5, and/or any other current or future video compression standard that includes provisions for spatial scalability.

In the illustrated embodiment, the scalable video encoder 210 encodes the full-resolution video 201 at multiple resolutions within multiple layers 225a-n, including a base layer encoded at the lowest base resolution and one or more enhancement layers encoded at progressively higher resolutions up to the full resolution.

For example, the base resolution may refer to the lowest resolution at which the video is encoded within the scalable video steam, which may be configured in any suitable manner, including as a camera setting (e.g., a software setting or physical button), firmware setting, an instruction to the camera, and so forth.

For example, for each layer aside from the full-resolution enhancement layer 225n, the full-resolution video 201 is fed through a down-sampling filter 203 to downscale the video to the appropriate resolution for that layer, and the downscaled video is then fed into the encoder 220. For the full-resolution enhancement layer 225n, however, the full-resolution video 201 is fed directly into the encoder 220 without downscaling since that layer is encoded at full resolution.

For each layer, the encoder 220 processes the video at the appropriate resolution through an encoding pipeline (e.g., loop filter 205, decoded picture buffer 207, processed inter-layer reference picture 209, motion-compensated prediction 211, intra-frame prediction 213, transform/quantize 215, inverse transform/inverse quantize 217, entropy coding 219), which leverages processed inter-layer reference pictures 209 for inter-layer dependencies. Each encoded layer 225a-n is then fed through a multiplexer 221, which multiplexes the layers 225a-n into a scalable video bitstream 223.

Whichever video encoder and spatial scalability approach is utilized by the scalable encoder 210, a matching mechanism is used to parse, demultiplex, and/or decode the scalable bitstream 223 on the host system 230 at the receiving end. However, the video analytics accelerator 240 on the host system 230 only needs to be capable of decoding the video bitstream of the base layer, as the video analytics pipeline implemented by the accelerator 240 is designed to operate at the base resolution.

For example, once the scalable video bitstream 223 is received at the host system 230, the video bitstream 223 is demultiplexed 231 into the lower-resolution base layer 225a and the higher-resolution enhancement layer(s) 225b-n by the host system 230. The host system 230 subsequently transfers the base layer 225a to the video analytics accelerator 240 over an input/output (I/O) interconnect on the system, which utilizes significantly less interconnect bandwidth than if the entire scalable bitstream 223—or even a single-layer full-resolution bitstream-were transferred over the I/O interconnect instead of the base layer 225a.

The base layer 225a is then processed through the video analytics pipeline implemented on the accelerator 240. For example, a video decoder 233 on the accelerator 240 (which may be implemented as a fixed-function or hardware-accelerated block) decodes the lower-resolution base layer video bitstream 225a and then feeds the decoded video into subsequent stages of the video analytics pipeline. In some embodiments, for example, the video analytics pipeline may include stages for color space conversion 235, downscaling 237 (if necessary), and/or various other tasks 239a-n tailored to a particular video analytics use case, such as pixel segmentation, neural network inference (e.g., detecting/inferring content in the video using artificial neural networks), and so forth.

The downscaling step 237 may or may not be needed depending on whether the resolution of the base layer 225a matches the input resolution requirements of subsequent inference stages 239a-n of the analytics pipeline (e.g., the input resolution of neural networks used to infer content within the video). For example, if the base layer resolution matches the expected video resolution of the inference stages 239a-n, the downscaling stage 237 may be omitted, as the base layer is already at the resolution required by the inference stages 239a-n. If the base layer resolution is higher than the inference resolution, however, the base layer may be downscaled 237 to the inference resolution prior to performing the inference stages 239a-n. Further, if the base layer resolution is lower than the inference resolution, the base layer may be upscaled 237 to the inference resolution prior to performing the inference stages 239a-n, or alternatively, the accelerator 240 may perform the entire video analytics pipeline on another layer 225 of the scalable video bitstream 223 instead of the base layer 225a (e.g., an intermediate layer with a higher resolution than the base layer that either matches, or is closer to, the inference resolution).

During the processing of the base-layer video stream through the various stages of the video analytics pipeline, a stream of analytics metadata is produced. However, since the metadata is generated based on the resolution of the base layer rather than the full resolution of the video, a base-layer-to-enhancement-layer registration process 251 may be utilized to ensure that the metadata is accurately represented in the full-resolution dimensions of the original video stream 201, which in most cases will entail a simple scaling of location data from the lower resolution of the base layer 225a to the full resolution of the original video 201 that is represented in the enhancement layer(s) 225b-n. If the metadata produced by the video analytics pipeline does not produce spatial location information, or otherwise does not provide localization information for the detected objects, the base-layer-to-enhancement-layer registration process 251 may be omitted.

While the accelerator 240 is processing the base layer 225a through the video analytics pipeline, the host system 230 may decode the entire scalable bitstream 223 at full resolution by processing all layers 225a-n (or at less-than-full resolution by processing a subset of layers 225a-n) through a decoding pipeline (e.g., by decoding 241, 243 the base and enhancement layers 225a-n into respective decoded picture buffers 245, 247 and performing inter-layer processing 249 for dependencies across layers).

In this manner, the metadata output by the video analytics accelerator 240—which is now represented in the space of the full-resolution video—can then be either multiplexed with the scalable video bitstream that was produced by the video source 210 and received by the host system 230, or with a transcoded bitstream that is re-encoded as a standard single-layer/non-scalable bitstream in a video codec of choice or as required by an upstream device or system onto which the video and associated metadata are transmitted. This video stream and integrated or associated metadata stream may then be stored on the system and/or transmitted via network connectivity available to the host system. The metadata may also be overlayed 253 on the decoded and reconstructed full-resolution video stream and displayed on or adjacent to the host system 230. The resulting metadata and video stream, either in its spatially scalable format, a format to which it has be transcoded, or as a raw video sequence, may also be forwarded on to any other application that can utilize the video and associated metadata accordingly.

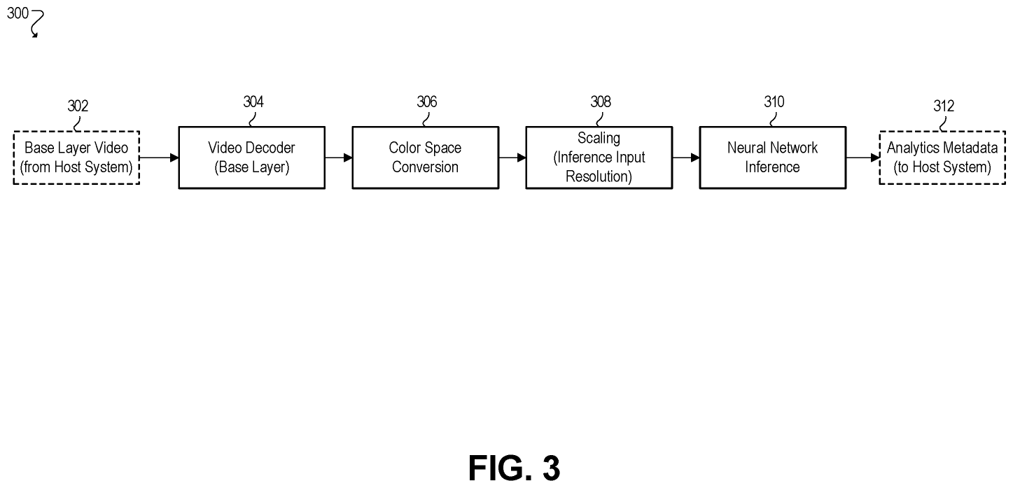

FIG. 3 illustrates an example of the processing pipeline 300 for a video analytics accelerator that leverages scalable video coding. In the illustrated example, the video analytics accelerator receives the base layer 302 of the video stream from the host system via an interconnect (e.g., a PCI Express (PCIe) high-speed serial bus interconnect), which forms the communication link between the host system and the video analytics accelerator. The received stream is decoded 304 using fixed-function video decode, which may be part of the media subsystem of the accelerator in some embodiments.

The decoded stream of frames in raw YUV format are subsequently processed via a color space conversion block 306 in order to produce frames in the RGB color space so that it can be further processed via the neural network inference stage 310. Prior to inference, however, the color-space-converted frames may be scaled down 308 to the expected input resolution of the neural network used in the subsequent inference block 310, if needed (e.g., if the input resolution of the neural network is lower than the base resolution of the video). For these measurements, a Tiny-YOLOv2 region-based classification neural network may be used for the inference-based detection stage 310 of the pipeline, which defines an input layer of dimensions 3×416×416. Therefore, the frames, in 3-channel RGB format, are scaled down to a resolution of 416×416 pixels for inference processing. The output of the inference stage is of dimensions 1×125×13×13 for each frame, representing a tensor with 13×13 grid cells each of which corresponds to 125 channels made up of the 5 bounding boxes predicted by the grid cell and the 25 data elements that describe each bounding box. This metadata is forwarded back to the host system via the same interconnect (e.g., PCIe) for further processing.

Performance data for this solution is provided below in Tables 3 and 4. For the purpose of these measurements, performance data for both H.264/MPEG-4 AVC and H.265/MPEG-H Part 2 (HEVC) video compression standard based base layers were considered, which are directly applicable to the SVC and SHVC scalability extensions of H.264/AVC and H.265/HEVC standards, respectively, and generally to the MPEG-5 Part 2 Low Complexity Enhancement Video Coding video compression standard. It should be noted, however, that the described solution is applicable more generally to any video codec that supports spatially scalable video encoding or any other type of layered video coding with multiple levels of video quality (e.g., spatial video resolutions or temporal frame rates). Additionally, for these measurements, the frequency at which the neural network inference stage is executed was set to a constant value across all measurements such that the period between inferences was greater than a single frame in order to guarantee that the video decode process was the rate-determining factor of the overall video analytics pipeline.

Table 3 compares the video analytics throughput measured on an accelerator when processing input video streams at their full/native resolution versus only a base layer of the streams at a lower resolution.

TABLE 3
Video analytics throughput for native-resolution
video streams versus lower-resolution base layers

| | | | Analytics Throughput at Various | | | |
|---|---|---|---|---|---|---|
| | | Analytics | Base Layer Resolutions | | | |
| | Native | Throughput at | | | | 416 × 416 |
| Video | Video | Native Resolution | 1920 × | 1280 × | 640 × | (Inference |
| Codec | Resolution | (Frames Per Second) | 1080 | 720 | 480 | Resolution) |
| AVC/ | UHD | 101.64 | 455.51 | 1040.27 | 2605.71 | 2812.67 |
| H.264 | (3840 × 2160) | | | | | |
| | Full HD | 455.51 | | 1040.27 | 2605.71 | 2812.67 |
| | (1920 × 1080) | | | | | |
| | Standard HD | 1040.27 | | | 2605.71 | 2812.67 |
| | (1280 × 720) | | | | | |
| | VGA | 2605.71 | | | | 2812.67 |
| | (640 × 480) | | | | | |
| HEVC/ | UHD | 116.74 | 400.83 | 919.41 | 2072.15 | 2894.21 |
| H.265 | (3840 × 2160) | | | | | |
| | Full HD | 400.83 | | 919.41 | 2072.15 | 2894.21 |
| | (1920 × 1080) | | | | | |
| | Standard HD | 919.41 | | | 2072.15 | 2894.21 |
| | (1280 × 720) | | | | | |
| | VGA | 2072.15 | | | | 2894.21 |
| | (640 × 480) | | | | | |

Table 4 compares the stream processing density measured on an accelerator when processing input video streams at their full/native resolution versus only a base layer of the streams at a lower resolution.

TABLE 4
Video analytics stream density for native-resolution video
streams versus lower-resolution base layers

| | | Analytics | Analytics Stream Density at Various | | | |
|---|---|---|---|---|---|---|
| | | Stream Density | Base Layer Resolutions | | | |
| | Native | at Native | | | | 416 × 416 |
| Video | Video | Resolution/30 fps | 1920 × | 1280 × | 640 × | (Inference |
| Codec | Resolution | (# of Video Streams) | 1080 | 720 | 480 | Resolution) |
| AVC/ | UHD | 3 | 15 | 34 | 86 | 93 |
| H.264 | (3840 × 2160) | | | | | |
| | Full HD | 15 | | 34 | 86 | 93 |
| | (1920 × 1080) | | | | | |
| | Standard HD | 34 | | | 86 | 93 |
| | (1280 × 720) | | | | | |
| | VGA | 86 | | | | 93 |
| | (640 × 480) | | | | | |
| HEVC/ | UHD | 3 | 13 | 30 | 71 | 102 |
| H.265 | (3840 × 2160) | | | | | |
| | Full HD | 13 | | 30 | 71 | 102 |
| | (1920 × 1080) | | | | | |
| | Standard HD | 30 | | | 71 | 102 |
| | (1280 × 720) | | | | | |
| | VGA | 71 | | | | 102 |
| | (640 × 480) | | | | | |

The performance data shown in Tables 3 and 4 is based on H.264/AVC and H.265/HEVC encoded base-layer video. In addition, the performance data is presented for four different native video resolutions (e.g., Ultra-High-Definition (UHD), Full HD, Standard HD, and VGA resolution), along with four applicable base-layer video resolutions that can be utilized in conjunction with the full-resolution source video.

The performance improvement achieved by the described solution (as shown by the performance data in Tables 1-4) may vary in different embodiments based on various factors, including the particular host processor and/or video analytics accelerator used in each embodiment, the video codec and parameters used for video encoding/decoding, the video analytics tasks performed, and so forth.

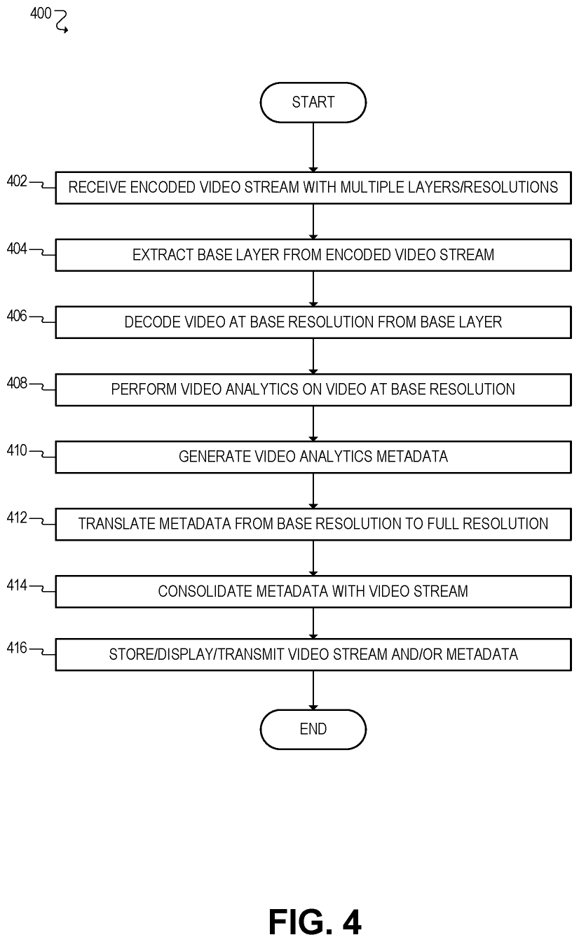

FIG. 4 illustrates a flowchart 400 for performing video analytics on a scalable coded video stream in accordance with certain embodiments. In some embodiments, for example, flowchart 400 may be performed by or using the example computing devices and systems described throughout this disclosure.

The process flow begins at block 402, where a computing device receives an encoded video stream from a camera or another video source (e.g., content distribution server, media repository). For example, the computing device may receive the encoded video stream over a network via a network interface controller (NIC), via an input/output (I/O) interface (e.g., a PCIe interconnect), or over any other type of interface or communication circuitry.

Moreover, the encoded video stream may contain video data encoded in multiple layers at multiple resolutions (e.g., different video resolutions and/or frame rates across the layers). For example, the video may be encoded at progressively higher resolutions across the various layers, ranging from a lowest base resolution to a highest full/native resolution of the video.

In some embodiments, for example, the encoded video stream may include a base layer that encodes the video at a lowest “base” resolution, along with one or more enhancement layers that encode the video at progressively higher resolutions, one of which is a full resolution layer that encodes the video at its full resolution (e.g., its original, native, or highest resolution). Moreover, at least some of the layers may encode the video with dependencies on other layer(s). For example, the base layer may encode the video at the base resolution without any dependencies on other layers, but some or all of the other layers may encode the video with dependencies on the base layer and/or other intermediate layer(s).

In some embodiments, for example, the encoded video stream may be a scalable coded video stream encoded using the scalable video coding techniques of current and/or future video codecs, including, but not limited to, H.264, H.265, MPEG-5, AV1, and/or VP9, among other examples.

The process flow then proceeds to block 404 to extract the base layer from the encoded video stream, which contains the video data encoded at the base resolution. In some embodiments, for example, a host processor of the computing device may extract the base layer from the encoded video stream and then send the base layer to a video analytics accelerator (e.g., via a PCIe interconnect) for decoding and further processing/analytics.

The process flow then proceeds to block 406 to decode the video at the base resolution from the base layer. In some embodiments, for example, the video analytics accelerator may use a hardware video decoder to decode the base layer into decoded video at the base resolution.

The process flow then proceeds to block 408 to perform video analytics on the video at the base resolution to detect content within the video (e.g., features, objects, actions). In some embodiments, for example, the video analytics accelerator may process the video at its base resolution through a video analytics or computer vision (CV) pipeline. For example, the video may be input into the video analytics pipeline at the base resolution, and the video analytics pipeline may perform various tasks to detect the content in the video.

In general, examples of the tasks that may be performed by a video analytics or CV pipeline include video encoding/decoding, preprocessing (e.g., color space conversion, scaling resizing, cropping), pixel segmentation, feature detection/extraction, object detection/tracking, object identification, facial recognition, event/action detection, scene recognition, motion estimation, pose estimation, camera/sensor fusion (e.g., fusing together visual/sensor data captured by multiple homogenous or heterogenous vision sensors, such as cameras, thermal sensors, lidar, radar), and so forth. Moreover, the tasks, processing modules, and/or models used by the video analytics or CV pipeline may be implemented using any suitable visual processing, artificial intelligence, and/or machine learning techniques, including artificial neural networks (ANNs), deep neural networks (DNNs), convolutional neural networks (CNNs) (e.g., Inception/ResNet CNN architectures), other deep learning neural networks or feed-forward artificial neural networks, pattern recognition, scale-invariant feature transforms (SIFT), principal component analysis (PCA), discrete cosine transforms (DCT), and so forth.

In some embodiments, for example, the pipeline may include one or more content recognition tasks (e.g., object detection/identification/tracking, action detection, scene recognition) performed or implemented using convolutional neural networks (CNNs) and/or other types of artificial neural network (ANNs) (e.g., a CNN trained to detect or identify certain types of objects).

In some cases, however, the input resolution of the neural network may be lower than the full resolution of the video and either equal to or lower than the base resolution of the video. If the input resolution of the neural network is equal to the base resolution of the video, the video may be fed into the neural network at the base resolution without performing any additional scaling. However, if the input resolution of the neural network is lower than the base resolution of the video, the video analytics pipeline may include a downscaling task to downscale the video from the base resolution to the input resolution of the neural network prior to feeding the video data through the neural network.

Alternatively, if the input resolution of the neural network is higher than the base resolution of the video, then flowchart 400 may be performed using another intermediate layer of the encoded video stream with a higher resolution than the base layer.

The process flow then proceeds to block 410 to generate video analytics metadata indicating the content detected in the video. In some embodiments, for example, the metadata may include labels and/or bounding boxes indicating the type and/or spatial location of content (e.g., features, objects, actions) detected within the respective frames of the video.

The process flow then proceeds to block 412 to optionally translate the metadata from the base resolution of the video to the full resolution of the video. For example, since the metadata identifies content detected based on analysis of the video at its base resolution, the metadata may identify spatial locations of that content relative to the base resolution of the video. As a result, the metadata may need to be translated or scaled to identify the spatial locations of that same content relative to the full resolution of the video. For example, the bounding boxes surrounding the content detected in the base resolution of the video may be scaled such that those bounding boxes surround the same content in the full resolution of the video.

The process flow then proceeds to block 414 to optionally consolidate the metadata with the video stream. For example, the metadata and the video may be multiplexed together and/or encoded/transcoded into an encoded video stream containing both the video and the associated metadata.

The process flow then proceeds to block 416 to optionally store, display, and/or transmit the video stream and/or metadata. For example, the video stream and/or metadata may be stored on a local storage device, displayed on a physical display device (e.g., with the metadata overlayed or adjacent to the video), transmitted to another destination over a network (e.g., for further analysis, storage, consumption/display on end-user devices), and so forth.

At this point, the flowchart may be complete. In some embodiments, however, the flowchart may restart and/or certain blocks may be repeated. For example, in some embodiments, the flowchart may restart at block 402 to continue receiving and processing encoded video streams.

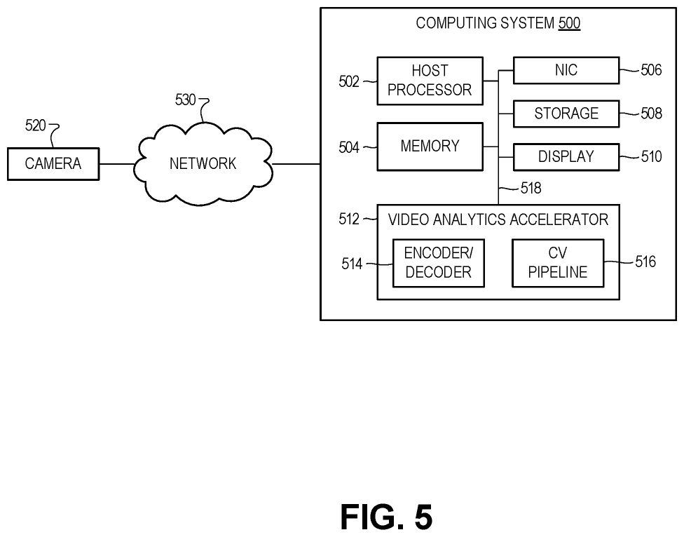

FIG. 5 illustrates an example embodiment of a computing system 500 for performing video analytics. In some embodiments, for example, computing system 500 may be used to implement the video analytics functionality described above in connection with FIGS. 1-4.

In the illustrated embodiment, computing system 500 includes a host processor 502 (e.g., a general-purpose processor, processor core, central processing unit (CPU), and/or other processing circuitry), memory 504, network interface controller (NIC) 506, storage device 508, display 510, and video analytics accelerator 512. Moreover, the respective components of computing system 500 are connected via interconnect 518, which may include any type or combination of interface or communication circuitry, including input/output (I/O) interfaces and interconnects (e.g., a peripheral component interconnect express (PCIe) interconnect), processor interconnects, memory buses, and so forth.

The video analytics accelerator 512 includes a hardware video encoder/decoder 514 and a computer vision (CV) pipeline accelerator 514. In some embodiments, for example, the video analytics accelerator 512 may be a vision processing unit (VPU), graphics processing unit (GPU), and/or any application-specific integrated circuit (ASIC) or field-programmable gate array (FPGA) with circuitry for accelerated video encoding/decoding and video analytics.

Computing system 500 is also connected to a camera 520 via network 530. In other embodiments, however, the camera 520 may be integrated with or otherwise connected to computing system 500 without passing through the network 530.

In some embodiments, computing system 500 may be used to implement the video analytics functionality described throughout this disclosure. For example, the camera 520 may capture, encode, and stream an encoded video stream to computing system 500 over network 530. The encoded video stream may contain video encoded in multiple layers at multiple resolutions. For example, the encoded video stream may be a scalable coded video stream with a base layer and one or more enhancement layers, which individually or collectively encode the video at various resolutions ranging from a base resolution (e.g., the lowest resolution) to the full or native resolution of the video (e.g., the highest resolution).

The encoded video stream is received by computing system 500 (e.g., via NIC 506), where the stream may initially be stored in memory 504 and/or processed by the host processor 502. For example, the host processor 502 may extract the base layer from the scalable coded video stream and send the base layer to the video analytics accelerator 512 via the interconnect 518.

The video analytics accelerator 512 may receive the base layer, decode the base layer using video encoder 514, and process the decoded video at the base resolution through the CV pipeline 514, which may perform various tasks to analyze and/or detect content in the video depending on the particular use case. For example, the tasks performed by the CV pipeline 514 may include color space conversion, scaling, pixel segmentation, content detection/recognition (e.g., object/action recognition, object identification, object tracking), and so forth.

The video analytics accelerator 512 then generates metadata indicating the content detected in the video, which may be multiplexed with the video, encoded and/or transcoded, and/or returned to the host processor 502 via the interconnect 518. The metadata and/or video may then be stored in the storage device 508, displayed on the display device 510, and/or transmitted over network 530 (e.g., for further analysis, storage, and/or consumption/display on an end-user device), among other examples.

### Example Computing Embodiments

The following sections present examples of various computing embodiments that may be used to implement the video analytics solution described throughout this disclosure. In particular, any of the devices, systems, or functionality described in the preceding sections may be implemented using the computing embodiments described below.

### Edge Computing

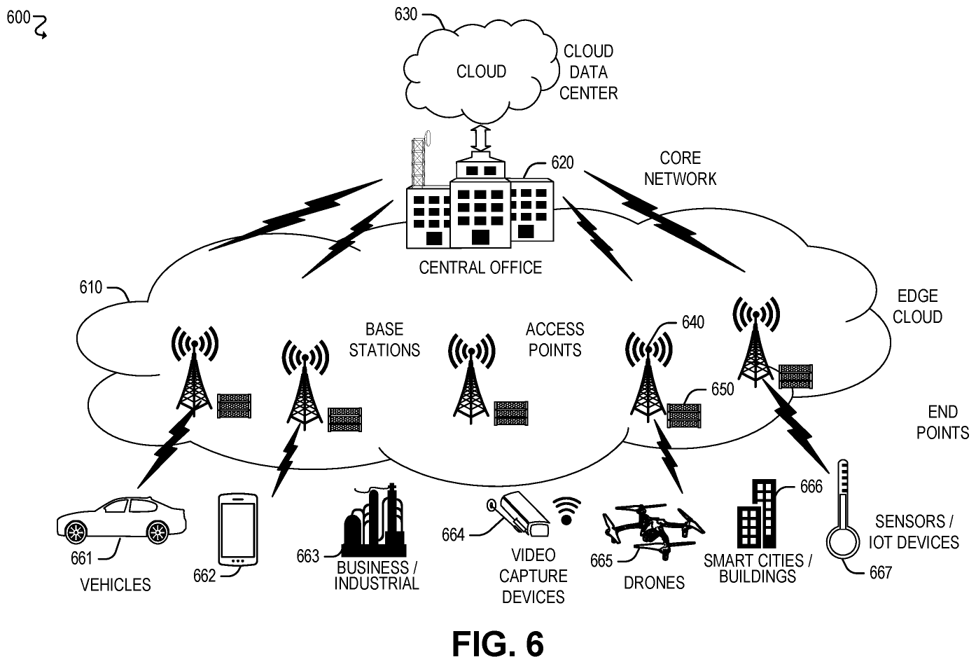

FIG. 6 is a block diagram 600 showing an overview of a configuration for edge computing, which includes a layer of processing referred to in many of the following examples as an “edge cloud”. As shown, the edge cloud 610 is co-located at an edge location, such as an access point or base station 640, a local processing hub 650, or a central office 620, and thus may include multiple entities, devices, and equipment instances. The edge cloud 610 is located much closer to the endpoint (consumer and producer) data sources 660 (e.g., autonomous vehicles 661, user equipment 662, business and industrial equipment 663, video capture devices 664, drones 665, smart cities and building devices 666, sensors and IoT devices 667, etc.) than the cloud data center 630. Compute, memory, and storage resources which are offered at the edges in the edge cloud 610 are critical to providing ultra-low latency response times for services and functions used by the endpoint data sources 660 as well as reduce network backhaul traffic from the edge cloud 610 toward cloud data center 630 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

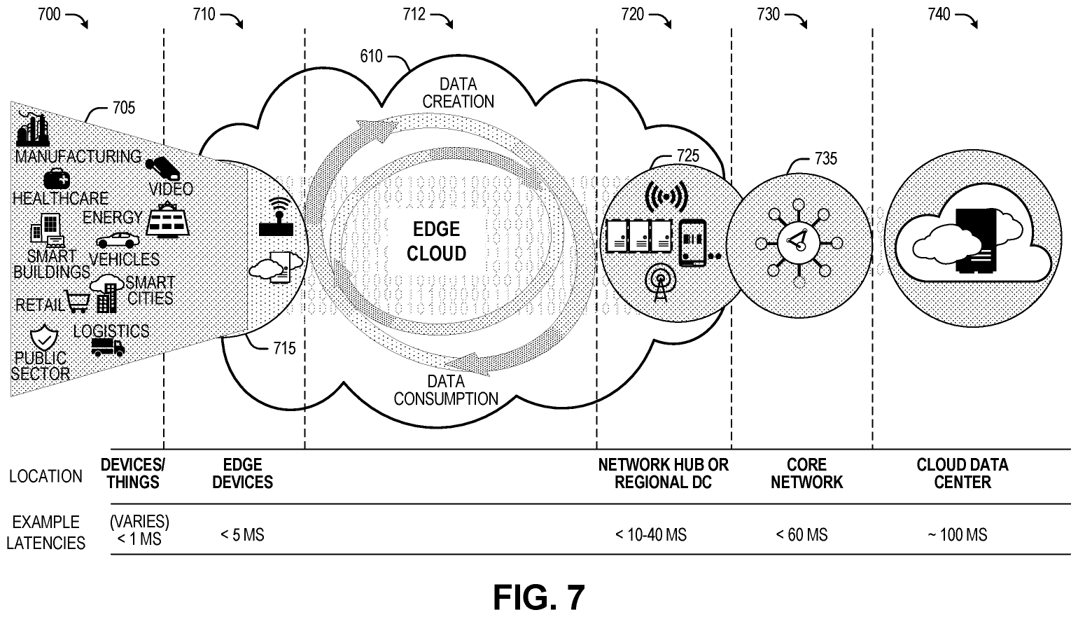

FIG. 7 illustrates operational layers among endpoints, an edge cloud, and cloud computing environments. Specifically, FIG. 7 depicts examples of computational use cases 705, utilizing the edge cloud 610 among multiple illustrative layers of network computing. The layers begin at an endpoint (devices and things) layer 700, which accesses the edge cloud 610 to conduct data creation, analysis, and data consumption activities. The edge cloud 610 may span multiple network layers, such as an edge devices layer 710 having gateways, on-premise servers, or network equipment (nodes 715) located in physically proximate edge systems; a network access layer 720, encompassing base stations, radio processing units, network hubs, regional data centers (DC), or local network equipment (equipment 725); and any equipment, devices, or nodes located therebetween (in layer 712, not illustrated in detail). The network communications within the edge cloud 610 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 700, under 5 ms at the edge devices layer 710, to even between 10 to 40 ms when communicating with nodes at the network access layer 720. Beyond the edge cloud 610 are core network 730 and cloud data center 740 layers, each with increasing latency (e.g., between 50-60 ms at the core network layer 730, to 100 or more ms at the cloud data center layer). As a result, operations at a core network data center 735 or a cloud data center 745, with latencies of at least 50 to 100 ms or more, will not be able to accomplish many time-critical functions of the use cases 705. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 735 or a cloud data center 745, a central office or content data network may be considered as being located within a “near edge” layer (“near” to the cloud, having high latency values when communicating with the devices and endpoints of the use cases 705), whereas an access point, base station, on-premise server, or network gateway may be considered as located within a “far edge” layer (“far” from the cloud, having low latency values when communicating with the devices and endpoints of the use cases 705). It will be understood that other categorizations of a particular network layer as constituting a “close”, “local”, “near”, “middle”, or “far” edge may be based on latency, distance, number of network hops, or other measurable characteristics, as measured from a source in any of the network layers 700-740.

The various use cases 705 may access resources under usage pressure from incoming streams, due to multiple services utilizing the edge cloud. To achieve results with low latency, the services executed within the edge cloud 610 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 610 may provide the ability to serve and respond to multiple applications of the use cases 705 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 610 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 610 (network layers 700-740), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 610.

As such, the edge cloud 610 is formed from network components and functional features operated by and within edge gateway nodes, edge aggregation nodes, or other edge compute nodes among network layers 710-730. The edge cloud 610 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 610 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

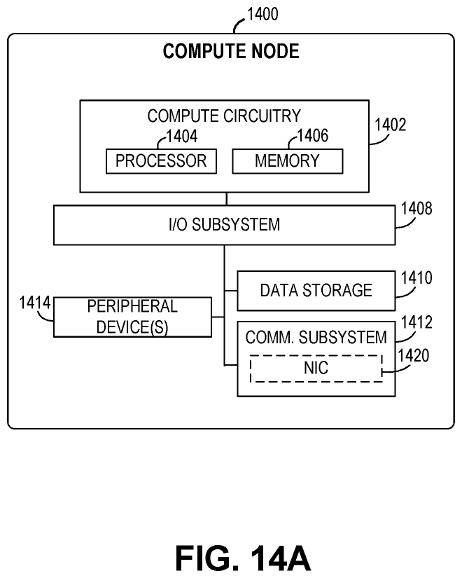

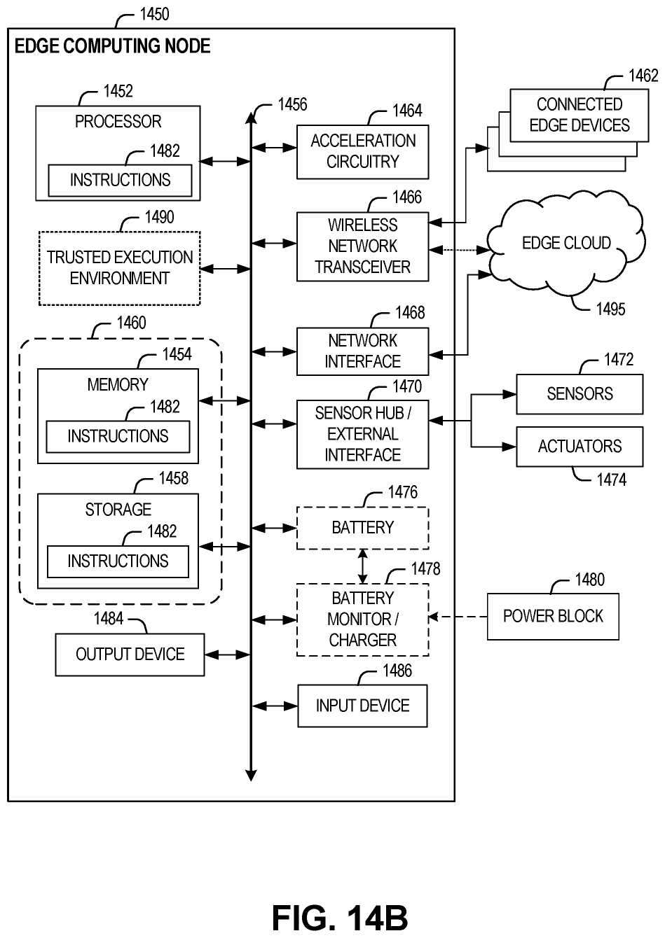

The network components of the edge cloud 610 may be servers, multi-tenant servers, appliance computing devices, and/or any other type of computing devices. For example, the edge cloud 610 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 14B. The edge cloud 610 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

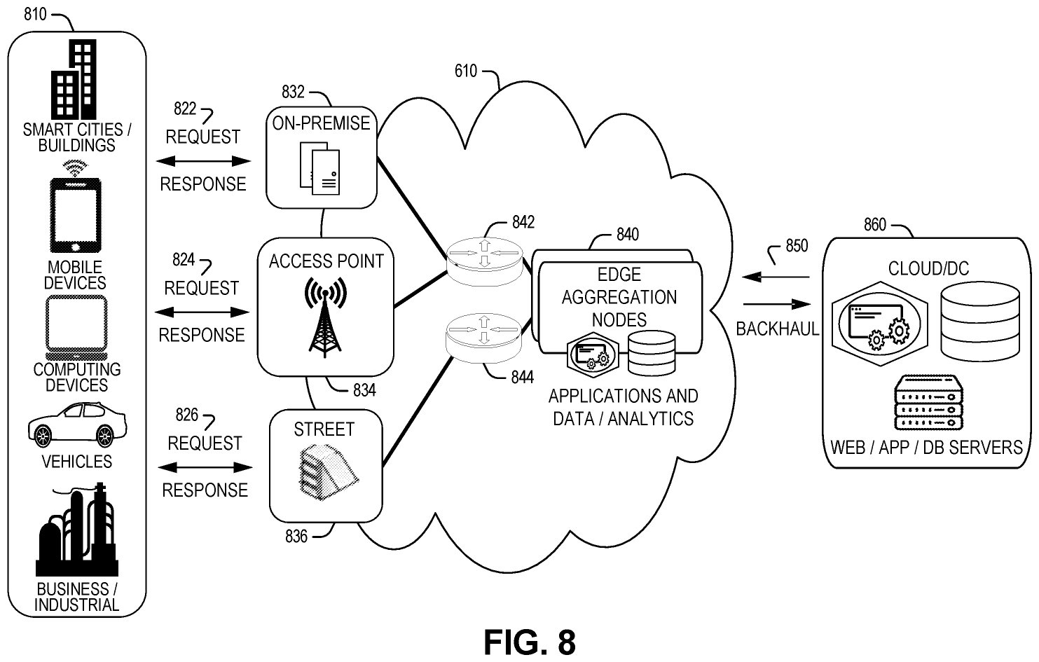

In FIG. 8, various client endpoints 810 (in the form of mobile devices, computers, autonomous vehicles, business computing equipment, industrial processing equipment) exchange requests and responses that are specific to the type of endpoint network aggregation. For instance, client endpoints 810 may obtain network access via a wired broadband network, by exchanging requests and responses 822 through an on-premise network system 832. Some client endpoints 810, such as mobile computing devices, may obtain network access via a wireless broadband network, by exchanging requests and responses 824 through an access point (e.g., cellular network tower) 834. Some client endpoints 810, such as autonomous vehicles may obtain network access for requests and responses 826 via a wireless vehicular network through a street-located network system 836. However, regardless of the type of network access, the TSP may deploy aggregation points 842, 844 within the edge cloud 610 to aggregate traffic and requests. Thus, within the edge cloud 610, the TSP may deploy various compute and storage resources, such as at edge aggregation nodes 840, to provide requested content. The edge aggregation nodes 840 and other systems of the edge cloud 610 are connected to a cloud or data center 860, which uses a backhaul network 850 to fulfill higher-latency requests from a cloud/data center for websites, applications, database servers, etc. Additional or consolidated instances of the edge aggregation nodes 840 and the aggregation points 842, 844, including those deployed on a single server framework, may also be present within the edge cloud 610 or other areas of the TSP infrastructure.

### Internet-of-Things

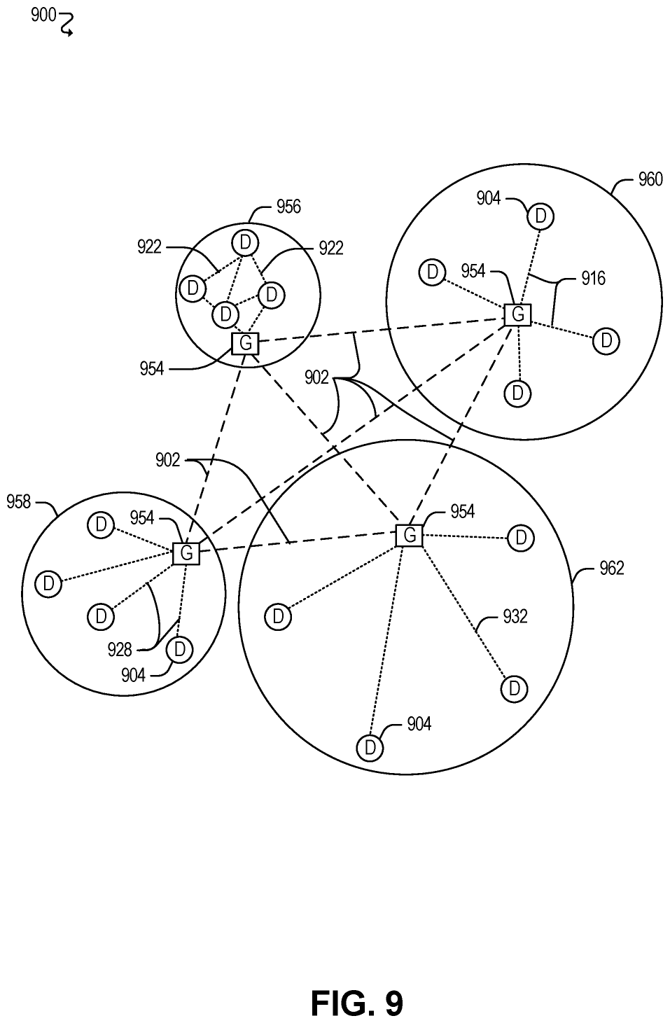

FIG. 9 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, doorbells (e.g., doorbell cameras), cameras, alarms, motion sensors, and the like. The IoT devices may be accessible through remote computers, servers, and other systems, for example, to control systems or access data.

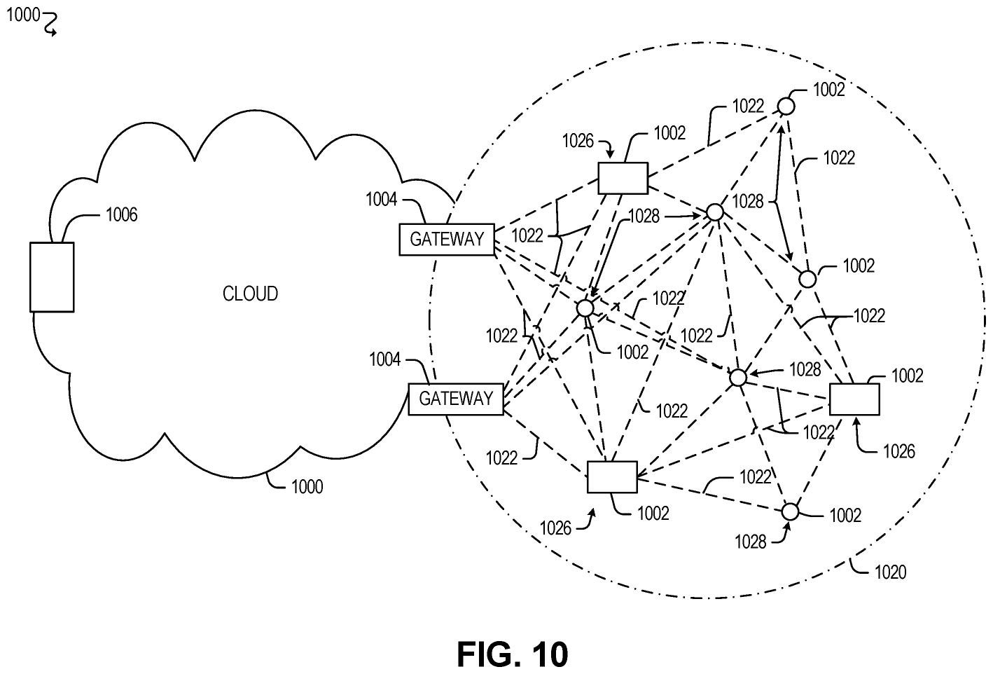

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 9 and 10, present a number of new challenges in a heterogeneous network of connectivity comprising a combination of wired and wireless technologies.

FIG. 9 specifically provides a simplified drawing of a domain topology that may be used for a number of internet-of-things (IoT) networks comprising IoT devices 904, with the IoT networks 956, 958, 960, 962, coupled through backbone links 902 to respective gateways 954. For example, a number of IoT devices 904 may communicate with a gateway 954, and with each other through the gateway 954. To simplify the drawing, not every IoT device 904, or communications link (e.g., link 916, 922, 928, or 932) is labeled. The backbone links 902 may include any number of wired or wireless technologies, including optical networks, and may be part of a local area network (LAN), a wide area network (WAN), or the Internet. Additionally, such communication links facilitate optical signal paths among both IoT devices 904 and gateways 954, including the use of MUXing/deMUXing components that facilitate interconnection of the various devices.

The network topology may include any number of types of IoT networks, such as a mesh network provided with the network 956 using Bluetooth low energy (BLE) links 922. Other types of IoT networks that may be present include a wireless local area network (WLAN) network 958 used to communicate with IoT devices 904 through IEEE 802.11 (Wi-Fi®) links 928, a cellular network 960 used to communicate with IoT devices 904 through an LTE/LTE-A (4G) or 5G cellular network, and a low-power wide area (LPWA) network 962, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into “fog” devices or integrated into “Edge” computing systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 904, such as over the backbone links 902, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability, and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 956, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 958, for instance, may use systems that perform standards conversion to provide multi-standard connectivity, enabling IoT devices 904 using different protocols to communicate. Further systems may provide seamless interconnectivity across a multi-standard infrastructure comprising visible Internet resources and hidden Internet resources.

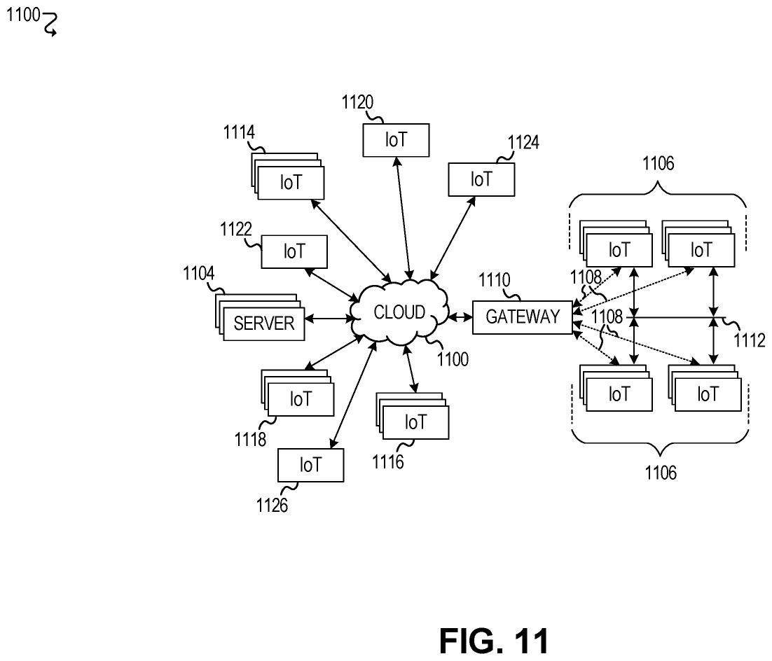

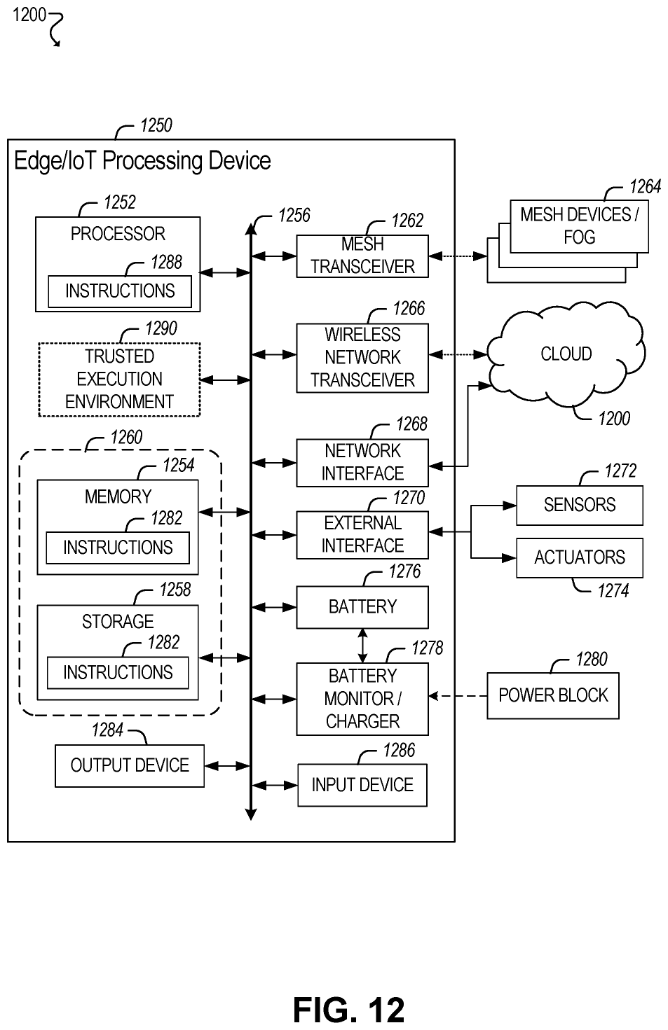

Communications in the cellular network 960, for instance, may be enhanced by systems that offload data, extend communications to more remote devices, or both. The LPWA network 962 may include systems that perform non-Internet protocol (IP) to IP interconnections, addressing, and routing. Further, each of the IoT devices 904 may include the appropriate transceiver for wide area communications with that device. Further, each IoT device 904 may include other transceivers for communications using additional protocols and frequencies. This is discussed further with respect to the communication environment and hardware of an IoT processing device depicted in FIGS. 11 and 12.

Finally, clusters of IoT devices may be equipped to communicate with other IoT devices as well as with a cloud network. This may allow the IoT devices to form an ad-hoc network between the devices, allowing them to function as a single device, which may be termed a fog device, fog platform, or fog network. This configuration is discussed further with respect to FIG. 10 below.

FIG. 10 illustrates a cloud computing network in communication with a mesh network of IoT devices (devices 1002) operating as a fog platform in a networked scenario. The mesh network of IoT devices may be termed a fog network 1020, established from a network of devices operating at the Edge of the cloud 1000. To simplify the diagram, not every IoT device 1002 is labeled.

The fog network 1020 may be considered to be a massively interconnected network wherein a number of IoT devices 1002 are in communications with each other, for example, by radio links 1022. The fog network 1020 may establish a horizontal, physical, or virtual resource platform that can be considered to reside between IoT Edge devices and cloud or data centers. A fog network, in some examples, may support vertically-isolated, latency-sensitive applications through layered, federated, or distributed computing, storage, and network connectivity operations. However, a fog network may also be used to distribute resources and services at and among the Edge and the cloud. Thus, references in the present document to the “Edge”, “fog”, and “cloud” are not necessarily discrete or exclusive of one another.

As an example, the fog network 1020 may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 1002 are shown in this example, gateways 1004, data aggregators 1026, and sensors 1028, although any combinations of IoT devices 1002 and functionality may be used. The gateways 1004 may be Edge devices that provide communications between the cloud 1000 and the fog network 1020, and may also provide the backend process function for data obtained from sensors 1028, such as motion data, flow data, temperature data, and the like. The data aggregators 1026 may collect data from any number of the sensors 1028, and perform the back end processing function for the analysis. The results, raw data, or both may be passed along to the cloud 1000 through the gateways 1004. The sensors 1028 may be full IoT devices 1002, for example, capable of both collecting data and processing the data. In some cases, the sensors 1028 may be more limited in functionality, for example, collecting the data and allowing the data aggregators 1026 or gateways 1004 to process the data.

Communications from any IoT device 1002 may be passed along a convenient path between any of the IoT devices 1002 to reach the gateways 1004. In these networks, the number of interconnections provide substantial redundancy, allowing communications to be maintained, even with the loss of a number of IoT devices 1002. Further, the use of a mesh network may allow IoT devices 1002 that are very low power or located at a distance from infrastructure to be used, as the range to connect to another IoT device 1002 may be much less than the range to connect to the gateways 1004.

The fog network 1020 provided from these IoT devices 1002 may be presented to devices in the cloud 1000, such as a server 1006, as a single device located at the Edge of the cloud 1000, e.g., a fog network operating as a device or platform. In this example, the alerts coming from the fog platform may be sent without being identified as coming from a specific IoT device 1002 within the fog network 1020. In this fashion, the fog network 1020 may be considered a distributed platform that provides computing and storage resources to perform processing or data-intensive tasks such as data analytics, data aggregation, and machine-learning, among others.

In some examples, the IoT devices 1002 may be configured using an imperative programming style, e.g., with each IoT device 1002 having a specific function and communication partners. However, the IoT devices 1002 forming the fog platform may be configured in a declarative programming style, enabling the IoT devices 1002 to reconfigure their operations and communications, such as to determine needed resources in response to conditions, queries, and device failures. As an example, a query from a user located at a server 1006 about the operations of a subset of equipment monitored by the IoT devices 1002 may result in the fog network 1020 device the IoT devices 1002, such as particular sensors 1028, needed to answer the query. The data from these sensors 1028 may then be aggregated and analyzed by any combination of the sensors 1028, data aggregators 1026, or gateways 1004, before being sent on by the fog network 1020 to the server 1006 to answer the query. In this example, IoT devices 1002 in the fog network 1020 may select the sensors 1028 used based on the query, such as adding data from flow sensors or temperature sensors. Further, if some of the IoT devices 1002 are not operational, other IoT devices 1002 in the fog network 1020 may provide analogous data, if available.

In other examples, the operations and functionality described herein may be embodied by an IoT or Edge compute device in the example form of an electronic processing system, within which a set or sequence of instructions may be executed to cause the electronic processing system to perform any one of the methodologies discussed herein, according to an example embodiment. The device may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine.

Further, while only a single machine may be depicted and referenced in the examples above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor, set of processors, or processing circuitry (e.g., a computer) to individually or jointly execute instructions to perform any one or more of the methodologies discussed herein. Accordingly, in various examples, applicable means for processing (e.g., processing, controlling, generating, evaluating, etc.) may be embodied by such processing circuitry.

FIG. 11 illustrates a drawing of a cloud computing network, or cloud 1100, in communication with a number of Internet of Things (IoT) devices. The cloud 1100 may represent the Internet, or may be a local area network (LAN), or a wide area network (WAN), such as a proprietary network for a company. The IoT devices may include any number of different types of devices, grouped in various combinations. For example, a traffic control group 1106 may include IoT devices along streets in a city. These IoT devices may include stoplights, traffic flow monitors, cameras, weather sensors, and the like. The traffic control group 1106, or other subgroups, may be in communication with the cloud 1100 through wired or wireless links 1108, such as LPWA links, and the like. Further, a wired or wireless sub-network 1112 may allow the IoT devices to communicate with each other, such as through a local area network, a wireless local area network, and the like. The IoT devices may use another device, such as a gateway 1110 or 1128 to communicate with remote locations such as the cloud 1100; the IoT devices may also use one or more servers 1130 to facilitate communication with the cloud 1100 or with the gateway 1110. For example, the one or more servers 1130 may operate as an intermediate network node to support a local Edge cloud or fog implementation among a local area network. Further, the gateway 1128 that is depicted may operate in a cloud-to-gateway-to-many Edge devices configuration, such as with the various IoT devices 1114, 1120, 1124 being constrained or dynamic to an assignment and use of resources in the cloud 1100.

Other example groups of IoT devices may include remote weather stations 1114, local information terminals 1116, alarm systems 1118, automated teller machines 1120, alarm panels 1122, or moving vehicles, such as emergency vehicles 1124 or other vehicles 1126, among many others. Each of these IoT devices may be in communication with other IoT devices, with servers 1104, with another IoT fog device or system (not shown, but depicted in FIG. 10), or a combination therein. The groups of IoT devices may be deployed in various residential, commercial, and industrial settings (including in both private or public environments).

As may be seen from FIG. 11, a large number of IoT devices may be communicating through the cloud 1100. This may allow different IoT devices to request or provide information to other devices autonomously. For example, a group of IoT devices (e.g., the traffic control group 1106) may request a current weather forecast from a group of remote weather stations 1114, which may provide the forecast without human intervention. Further, an emergency vehicle 1124 may be alerted by an automated teller machine 1120 that a burglary is in progress. As the emergency vehicle 1124 proceeds towards the automated teller machine 1120, it may access the traffic control group 1106 to request clearance to the location, for example, by lights turning red to block cross traffic at an intersection in sufficient time for the emergency vehicle 1124 to have unimpeded access to the intersection.

Clusters of IoT devices, such as the remote weather stations 1114 or the traffic control group 1106, may be equipped to communicate with other IoT devices as well as with the cloud 1100. This may allow the IoT devices to form an ad-hoc network between the devices, allowing them to function as a single device, which may be termed a fog device or system (e.g., as described above with reference to FIG. 10).

FIG. 12 is a block diagram of an example of components that may be present in an IoT device 1250 for implementing the techniques described herein. The IoT device 1250 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1250, or as components otherwise incorporated within a chassis of a larger system. Additionally, the block diagram of FIG. 12 is intended to depict a high-level view of components of the IoT device 1250. However, some of the components shown may be omitted, additional components may be present, and different arrangement of the components shown may occur in other implementations.

The IoT device 1250 may include processor circuitry in the form of, for example, a processor 1252, which may be a microprocessor, a multi-core processor, a multithreaded processor, an ultra-low voltage processor, an embedded processor, or other known processing elements. The processor 1252 may be a part of a system on a chip (SoC) in which the processor 1252 and other components are formed into a single integrated circuit, or a single package, such as the Edison™ or Galileo™ SoC boards from Intel. As an example, the processor 1252 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc.

The processor 1252 may communicate with a system memory 1254 over an interconnect 1256 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1258 may also couple to the processor 1252 via the interconnect 1256. In an example the storage 1258 may be implemented via a solid state disk drive (SSDD). Other devices that may be used for the storage 1258 include flash memory cards, such as SD cards, microSD cards, xD picture cards, and the like, and USB flash drives. In low power implementations, the storage 1258 may be on-die memory or registers associated with the processor 1252. However, in some examples, the storage 1258 may be implemented using a micro hard disk drive (HDD). Further, any number of new technologies may be used for the storage 1258 in addition to, or instead of, the technologies described, such resistance change memories, phase change memories, holographic memories, or chemical memories, among others.

The components may communicate over the interconnect 1256. The interconnect 1256 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1256 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components 1262, 1266, 1268, or 1270. Accordingly, in various examples, applicable means for communicating (e.g., receiving, transmitting, etc.) may be embodied by such communications circuitry.

The interconnect 1256 may couple the processor 1252 to a mesh transceiver 1262, for communications with other mesh devices 1264. The mesh transceiver 1262 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee© standard, among others. Any number of radios, configured for a particular wireless communication protocol, may be used for the connections to the mesh devices 1264. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1262 may communicate using multiple standards or radios for communications at different range. For example, the IoT device 1250 may communicate with close devices, e.g., within about 10 meters, using a local transceiver based on BLE, or another low power radio, to save power. More distant mesh devices 1264, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1266 may be included to communicate with devices or services in the cloud 1200 via local or wide area network protocols. The wireless network transceiver 1266 may be a LPWA transceiver that follows the IEEE 802.15.4, or IEEE 802.15.4g standards, among others. The IoT device 1250 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1262 and wireless network transceiver 1266, as described herein. For example, the radio transceivers 1262 and 1266 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 1262 and 1266 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It may be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1266, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1268 may be included to provide a wired communication to the cloud 1200 or to other devices, such as the mesh devices 1264. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1268 may be included to allow connect to a second network, for example, a NIC 1268 providing communications to the cloud over Ethernet, and a second NIC 1268 providing communications to other devices over another type of network.

The interconnect 1256 may couple the processor 1252 to an external interface 1270 that is used to connect external devices or subsystems. The external devices may include sensors 1272, such as accelerometers, level sensors, flow sensors, optical light sensors, camera sensors, temperature sensors, a global positioning system (GPS) sensors, pressure sensors, barometric pressure sensors, and the like. The external interface 1270 further may be used to connect the IoT device 1250 to actuators 1274, such as power switches, valve actuators, an audible sound generator, a visual warning device, and the like.

In some optional examples, various input/output (I/O) devices may be present within, or connected to, the IoT device 1250. For example, a display or other output device 1284 may be included to show information, such as sensor readings or actuator position. An input device 1286, such as a touch screen or keypad may be included to accept input. An output device 1286 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1250.

A battery 1276 may power the IoT device 1250, although in examples in which the IoT device 1250 is mounted in a fixed location, it may have a power supply coupled to an electrical grid. The battery 1276 may be a lithium ion battery, or a metal-air battery, such as a zinc-air battery, an aluminum-air battery, a lithium-air battery, and the like.

A battery monitor/charger 1278 may be included in the IoT device 1250 to track the state of charge (SoCh) of the battery 1276. The battery monitor/charger 1278 may be used to monitor other parameters of the battery 1276 to provide failure predictions, such as the state of health (SoH) and the state of function (SoF) of the battery 1276. The battery monitor/charger 1278 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1278 may communicate the information on the battery 1276 to the processor 1252 over the interconnect 1256. The battery monitor/charger 1278 may also include an analog-to-digital (ADC) convertor that allows the processor 1252 to directly monitor the voltage of the battery 1276 or the current flow from the battery 1276. The battery parameters may be used to determine actions that the IoT device 1250 may perform, such as transmission frequency, mesh network operation, sensing frequency, and the like.

A power block 1280, or other power supply coupled to a grid, may be coupled with the battery monitor/charger 1278 to charge the battery 1276. In some examples, the power block 1280 may be replaced with a wireless power receiver to obtain the power wirelessly, for example, through a loop antenna in the IoT device 1250. A wireless battery charging circuit, such as an LTC4020 chip from Linear Technologies of Milpitas, Calif., among others, may be included in the battery monitor/charger 1278. The specific charging circuits chosen depend on the size of the battery 1276, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1258 may include instructions 1282 in the form of software, firmware, or hardware commands to implement the techniques described herein. Although such instructions 1282 are shown as code blocks included in the memory 1254 and the storage 1258, it may be understood that any of the code blocks may be replaced with hardwired circuits, for example, built into an application specific integrated circuit (ASIC).

In an example, the instructions 1282 provided via the memory 1254, the storage 1258, or the processor 1252 may be embodied as a non-transitory, machine readable medium 1260 including code to direct the processor 1252 to perform electronic operations in the IoT device 1250. The processor 1252 may access the non-transitory, machine readable medium 1260 over the interconnect 1256. For instance, the non-transitory, machine readable medium 1260 may be embodied by devices described for the storage 1258 of FIG. 12 or may include specific storage units such as optical disks, flash drives, or any number of other hardware devices. The non-transitory, machine readable medium 1260 may include instructions to direct the processor 1252 to perform a specific sequence or flow of actions, for example, as described with respect to the flowchart(s) and block diagram(s) of operations and functionality depicted above.

Also in a specific example, the instructions 1288 on the processor 1252 (separately, or in combination with the instructions 1288 of the machine readable medium 1260) may configure execution or operation of a trusted execution environment (TEE) 1290. In an example, the TEE 1290 operates as a protected area accessible to the processor 1252 for secure execution of instructions and secure access to data. Various implementations of the TEE 1290, and an accompanying secure area in the processor 1252 or the memory 1254 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1250 through the TEE 1290 and the processor 1252.

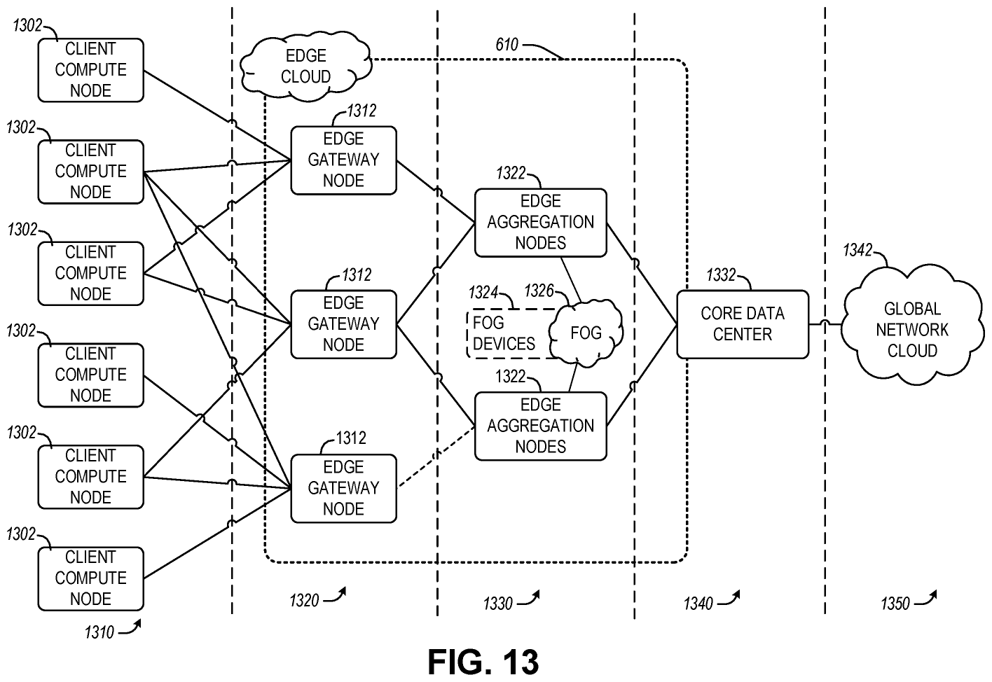

At a more generic level, an Edge computing system may be described to encompass any number of deployments operating in an Edge cloud 610, which provide coordination from client and distributed computing devices. FIG. 13 provides a further abstracted overview of layers of distributed compute deployed among an Edge computing environment for purposes of illustration.

FIG. 13 generically depicts an Edge computing system for providing Edge services and applications to multi-stakeholder entities, as distributed among one or more client compute nodes 1302, one or more Edge gateway nodes 1312, one or more Edge aggregation nodes 1322, one or more core data centers 1332, and a global network cloud 1342, as distributed across layers of the network. The implementation of the Edge computing system may be provided at or on behalf of a telecommunication service provider (“telco”, or “TSP”), internet-of-things service provider, cloud service provider (CSP), enterprise entity, or any other number of entities.

Each node or device of the Edge computing system is located at a particular layer corresponding to layers 1310, 1320, 1330, 1340, 1350. For example, the client compute nodes 1302 are each located at an endpoint layer 1310, while each of the Edge gateway nodes 1312 are located at an Edge devices layer 1320 (local level) of the Edge computing system. Additionally, each of the Edge aggregation nodes 1322 (and/or fog devices 1324, if arranged or operated with or among a fog networking configuration 1326) are located at a network access layer 1330 (an intermediate level). Fog computing (or “fogging”) generally refers to extensions of cloud computing to the Edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with Edge computing as discussed herein; many of the Edge computing aspects discussed herein are applicable to fog networks, fogging, and fog configurations. Further, aspects of the Edge computing systems discussed herein may be configured as a fog, or aspects of a fog may be integrated into an Edge computing architecture.

The core data center 1332 is located at a core network layer 1340 (e.g., a regional or geographically-central level), while the global network cloud 1342 is located at a cloud data center layer 1350 (e.g., a national or global layer). The use of “core” is provided as a term for a centralized network location-deeper in the network-which is accessible by multiple Edge nodes or components; however, a “core” does not necessarily designate the “center” or the deepest location of the network. Accordingly, the core data center 1332 may be located within, at, or near the Edge cloud 610.

Although an illustrative number of client compute nodes 1302, Edge gateway nodes 1312, Edge aggregation nodes 1322, core data centers 1332, global network clouds 1342 are shown in FIG. 13, it should be appreciated that the Edge computing system may include more or fewer devices or systems at each layer. Additionally, as shown in FIG. 13, the number of components of each layer 1310, 1320, 1330, 1340, 1350 generally increases at each lower level (i.e., when moving closer to endpoints). As such, one Edge gateway node 1312 may service multiple client compute nodes 1302, and one Edge aggregation node 1322 may service multiple Edge gateway nodes 1312.

Consistent with the examples provided herein, each client compute node 1302 may be embodied as any type of end point component, device, appliance, or “thing” capable of communicating as a producer or consumer of data. Further, the label “node” or “device” as used in the Edge computing system 1300 does not necessarily mean that such node or device operates in a client or agent/minion/follower role; rather, any of the nodes or devices in the Edge computing system 1300 refer to individual entities, nodes, or subsystems which include discrete or connected hardware or software configurations to facilitate or use the Edge cloud 610.

As such, the Edge cloud 610 is formed from network components and functional features operated by and within the Edge gateway nodes 1312 and the Edge aggregation nodes 1322 of layers 1320, 1330, respectively. The Edge cloud 610 may be embodied as any type of network that provides Edge computing and/or storage resources which are proximately located to radio access network (RAN) capable endpoint devices (e.g., mobile computing devices, IoT devices, smart devices, etc.), which are shown in FIG. 13 as the client compute nodes 1302. In other words, the Edge cloud 610 may be envisioned as an “Edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the Edge cloud 610 may form a portion of or otherwise provide an ingress point into or across a fog networking configuration 1326 (e.g., a network of fog devices 1324, not shown in detail), which may be embodied as a system-level horizontal and distributed architecture that distributes resources and services to perform a specific function. For instance, a coordinated and distributed network of fog devices 1324 may perform computing, storage, control, or networking aspects in the context of an IoT system arrangement. Other networked, aggregated, and distributed functions may exist in the Edge cloud 610 between the cloud data center layer 1350 and the client endpoints (e.g., client compute nodes 1302). Some of these are discussed in the following sections in the context of network functions or service virtualization, including the use of virtual Edges and virtual services which are orchestrated for multiple stakeholders.

The Edge gateway nodes 1312 and the Edge aggregation nodes 1322 cooperate to provide various Edge services and security to the client compute nodes 1302. Furthermore, because each client compute node 1302 may be stationary or mobile, each Edge gateway node 1312 may cooperate with other Edge gateway devices to propagate presently provided Edge services and security as the corresponding client compute node 1302 moves about a region. To do so, each of the Edge gateway nodes 1312 and/or Edge aggregation nodes 1322 may support multiple tenancy and multiple stakeholder configurations, in which services from (or hosted for) multiple service providers and multiple consumers may be supported and coordinated across a single or multiple compute devices.

### Computing Devices and Systems

In further examples, any of the compute nodes or devices discussed with reference to the present edge computing systems and environment may be fulfilled based on the components depicted in FIGS. 14A and 14B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 14A, an edge compute node 1400 includes a compute engine (also referred to herein as “compute circuitry”) 1402, an input/output (I/O) subsystem 1408, data storage 1410, a communication circuitry subsystem 1412, and, optionally, one or more peripheral devices 1414. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1400 may be embodied as any type of engine, device, or collection of devices capable of performing various compute functions. In some examples, the compute node 1400 may be embodied as a single device such as an integrated circuit, an embedded system, a field-programmable gate array (FPGA), a system-on-a-chip (SOC), or other integrated system or device. In the illustrative example, the compute node 1400 includes or is embodied as a processor 1404 and a memory 1406. The processor 1404 may be embodied as any type of processor capable of performing the functions described herein (e.g., executing an application). For example, the processor 1404 may be embodied as a multi-core processor(s), a microcontroller, a processing unit, a specialized or special purpose processing unit, or other processor or processing/controlling circuit.

In some examples, the processor 1404 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 1404 may work in coordination with each other to execute many types of operations and instructions within and on behalf of the compute node 1400.

The memory 1406 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1406 may be integrated into the processor 1404. The memory 1406 may store various software and data used during operation such as one or more applications, data operated on by the application(s), libraries, and drivers.

The compute circuitry 1402 is communicatively coupled to other components of the compute node 1400 via the I/O subsystem 1408, which may be embodied as circuitry and/or components to facilitate input/output operations with the compute circuitry 1402 (e.g., with the processor 1404 and/or the main memory 1406) and other components of the compute circuitry 1402. For example, the I/O subsystem 1408 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1408 may form a portion of a system-on-a-chip (SoC) and be incorporated, along with one or more of the processor 1404, the memory 1406, and other components of the compute circuitry 1402, into the compute circuitry 1402.

The one or more illustrative data storage devices 1410 may be embodied as any type of devices configured for short-term or long-term storage of data such as, for example, memory devices and circuits, memory cards, hard disk drives, solid-state drives, or other data storage devices. Individual data storage devices 1410 may include a system partition that stores data and firmware code for the data storage device 1410. Individual data storage devices 1410 may also include one or more operating system partitions that store data files and executables for operating systems depending on, for example, the type of compute node 1400.

The communication circuitry 1412 may be embodied as any communication circuit, device, or collection thereof, capable of enabling communications over a network between the compute circuitry 1402 and another compute device (e.g., an edge gateway of an implementing edge computing system). The communication circuitry 1412 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1412 includes a network interface controller (NIC) 1420, which may also be referred to as a host fabric interface (HFI). The NIC 1420 may be embodied as one or more add-in-boards, daughter cards, network interface cards, controller chips, chipsets, or other devices that may be used by the compute node 1400 to connect with another compute device (e.g., an edge gateway node). In some examples, the NIC 1420 may be embodied as part of a system-on-a-chip (SoC) that includes one or more processors, or included on a multichip package that also contains one or more processors. In some examples, the NIC 1420 may include a local processor (not shown) and/or a local memory (not shown) that are both local to the NIC 1420. In such examples, the local processor of the NIC 1420 may be capable of performing one or more of the functions of the compute circuitry 1402 described herein. Additionally, or alternatively, in such examples, the local memory of the NIC 1420 may be integrated into one or more components of the client compute node at the board level, socket level, chip level, and/or other levels.

Additionally, in some examples, a respective compute node 1400 may include one or more peripheral devices 1414. Such peripheral devices 1414 may include any type of peripheral device found in a compute device or server such as audio input devices, a display, other input/output devices, interface devices, and/or other peripheral devices, depending on the particular type of the compute node 1400. In further examples, the compute node 1400 may be embodied by a respective edge compute node (whether a client, gateway, or aggregation node) in an edge computing system or like forms of appliances, computers, subsystems, circuitry, or other components.

In a more detailed example, FIG. 14B illustrates a block diagram of an example of components that may be present in an edge computing node 1450 for implementing the techniques (e.g., operations, processes, methods, and methodologies) described herein. This edge computing node 1450 provides a closer view of the respective components of node 1400 when implemented as or as part of a computing device (e.g., as a mobile device, a base station, server, gateway, etc.). The edge computing node 1450 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1450, or as components otherwise incorporated within a chassis of a larger system.

The edge computing device 1450 may include processing circuitry in the form of a processor 1452, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1452 may be a part of a system on a chip (SoC) in which the processor 1452 and other components are formed into a single integrated circuit, or a single package, such as the Edison™ or Galileo™ SoC boards from Intel Corporation, Santa Clara, Calif. As an example, the processor 1452 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1452 and accompanying circuitry may be provided in a single socket form factor, multiple socket form factor, or a variety of other formats, including in limited hardware configurations or configurations that include fewer than all elements shown in FIG. 14B.

The processor 1452 may communicate with a system memory 1454 over an interconnect 1456 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1458 may also couple to the processor 1452 via the interconnect 1456. In an example, the storage 1458 may be implemented via a solid-state disk drive (SSDD). Other devices that may be used for the storage 1458 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory includingthe metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1458 may be on-die memory or registers associated with the processor 1452. However, in some examples, the storage 1458 may be implemented using a micro hard disk drive (HDD). Further, any number of new technologies may be used for the storage 1458 in addition to, or instead of, the technologies described, such resistance change memories, phase change memories, holographic memories, or chemical memories, among others.

The components may communicate over the interconnect 1456. The interconnect 1456 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1456 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1456 may couple the processor 1452 to a transceiver 1466, for communications with the connected edge devices 1462. The transceiver 1466 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee© standard, among others. Any number of radios, configured for a particular wireless communication protocol, may be used for the connections to the connected edge devices 1462. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1466 (or multiple transceivers) may communicate using multiple standards or radios for communications at a different range. For example, the edge computing node 1450 may communicate with close devices, e.g., within about 10 meters, using a local transceiver based on Bluetooth Low Energy (BLE), or another low power radio, to save power. More distant connected edge devices 1462, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1466 (e.g., a radio transceiver) may be included to communicate with devices or services in a cloud (e.g., an edge cloud 1495) via local or wide area network protocols. The wireless network transceiver 1466 may be a low-power wide-area (LPWA) transceiver that follows the IEEE 802.15.4, or IEEE 802.15.4g standards, among others. The edge computing node 1450 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1466, as described herein. For example, the transceiver 1466 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1466 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1468 may be included to provide a wired communication to nodes of the edge cloud 1495 or to other devices, such as the connected edge devices 1462 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1468 may be included to enable connecting to a second network, for example, a first NIC 1468 providing communications to the cloud over Ethernet, and a second NIC 1468 providing communications to other devices over another type of network.

Given the variety of types of applicable communications from the device to another component or network, applicable communications circuitry used by the device may include or be embodied by any one or more of components 1464, 1466, 1468, or 1470. Accordingly, in various examples, applicable means for communicating (e.g., receiving, transmitting, etc.) may be embodied by such communications circuitry.

The edge computing node 1450 may include or be coupled to acceleration circuitry 1464, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1456 may couple the processor 1452 to a sensor hub or external interface 1470 that is used to connect additional devices or subsystems. The devices may include sensors 1472, such as accelerometers, level sensors, flow sensors, optical light sensors, camera sensors, temperature sensors, global navigation system (e.g., GPS) sensors, pressure sensors, barometric pressure sensors, and the like. The hub or interface 1470 further may be used to connect the edge computing node 1450 to actuators 1474, such as power switches, valve actuators, an audible sound generator, a visual warning device, and the like.

In some optional examples, various input/output (I/O) devices may be present within or connected to, the edge computing node 1450. For example, a display or other output device 1484 may be included to show information, such as sensor readings or actuator position. An input device 1486, such as a touch screen or keypad may be included to accept input. An output device 1484 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1450. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1476 may power the edge computing node 1450, although, in examples in which the edge computing node 1450 is mounted in a fixed location, it may have a power supply coupled to an electrical grid, or the battery may be used as a backup or for temporary capabilities. The battery 1476 may be a lithium ion battery, or a metal-air battery, such as a zinc-air battery, an aluminum-air battery, a lithium-air battery, and the like.

A battery monitor/charger 1478 may be included in the edge computing node 1450 to track the state of charge (SoCh) of the battery 1476, if included. The battery monitor/charger 1478 may be used to monitor other parameters of the battery 1476 to provide failure predictions, such as the state of health (SoH) and the state of function (SoF) of the battery 1476. The battery monitor/charger 1478 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1478 may communicate the information on the battery 1476 to the processor 1452 over the interconnect 1456. The battery monitor/charger 1478 may also include an analog-to-digital (ADC) converter that enables the processor 1452 to directly monitor the voltage of the battery 1476 or the current flow from the battery 1476. The battery parameters may be used to determine actions that the edge computing node 1450 may perform, such as transmission frequency, mesh network operation, sensing frequency, and the like.

A power block 1480, or other power supply coupled to a grid, may be coupled with the battery monitor/charger 1478 to charge the battery 1476. In some examples, the power block 1480 may be replaced with a wireless power receiver to obtain the power wirelessly, for example, through a loop antenna in the edge computing node 1450. A wireless battery charging circuit, such as an LTC4020 chip from Linear Technologies of Milpitas, Calif., among others, may be included in the battery monitor/charger 1478. The specific charging circuits may be selected based on the size of the battery 1476, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1458 may include instructions 1482 in the form of software, firmware, or hardware commands to implement the techniques described herein. Although such instructions 1482 are shown as code blocks included in the memory 1454 and the storage 1458, it may be understood that any of the code blocks may be replaced with hardwired circuits, for example, built into an application specific integrated circuit (ASIC).

In an example, the instructions 1482 provided via the memory 1454, the storage 1458, or the processor 1452 may be embodied as a non-transitory, machine-readable medium 1460 including code to direct the processor 1452 to perform electronic operations in the edge computing node 1450. The processor 1452 may access the non-transitory, machine-readable medium 1460 over the interconnect 1456. For instance, the non-transitory, machine-readable medium 1460 may be embodied by devices described for the storage 1458 or may include specific storage units such as optical disks, flash drives, or any number of other hardware devices. The non-transitory, machine-readable medium 1460 may include instructions to direct the processor 1452 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1482 on the processor 1452 (separately, or in combination with the instructions 1482 of the machine readable medium 1460) may configure execution or operation of a trusted execution environment (TEE) 1490. In an example, the TEE 1490 operates as a protected area accessible to the processor 1452 for secure execution of instructions and secure access to data. Various implementations of the TEE 1490, and an accompanying secure area in the processor 1452 or the memory 1454 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1450 through the TEE 1490 and the processor 1452.

### Machine-Readable Medium and Distributed Software Instructions

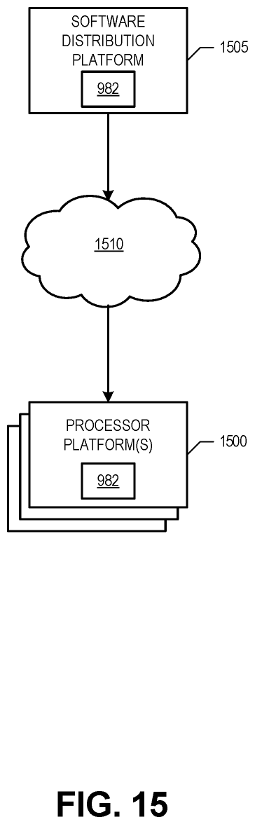

FIG. 15 illustrates an example software distribution platform 1505 to distribute software, such as the example computer readable instructions 1482 of FIG. 14B, to one or more devices, such as example processor platform(s) 1500 and/or example connected edge devices, gateways, and/or sensors described throughout this disclosure. The example software distribution platform 1505 may be implemented by any computer server, data facility, cloud service, etc., capable of storing and transmitting software to other computing devices (e.g., third parties, example connected edge devices described throughout this disclosure). Example connected edge devices may be customers, clients, managing devices (e.g., servers), third parties (e.g., customers of an entity owning and/or operating the software distribution platform 1505). Example connected edge devices may operate in commercial and/or home automation environments. In some examples, a third party is a developer, a seller, and/or a licensor of software such as the example computer readable instructions 1482 of FIG. 14B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 15, the software distribution platform 1505 includes one or more servers and one or more storage devices. The storage devices store the computer readable instructions 1482. The one or more servers of the example software distribution platform 1505 are in communication with a network 1510, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1482 from the software distribution platform 1505. For example, the software, which may correspond to the example computer readable instructions described throughout this disclosure, may be downloaded to the example processor platform(s) 1500 (e.g., example connected edge devices), which is/are to execute the computer readable instructions 1482 to implement the functionality described throughout this disclosure. In some examples, one or more servers of the software distribution platform 1505 are communicatively connected to one or more security domains and/or security devices through which requests and transmissions of the example computer readable instructions 1482 must pass. In some examples, one or more servers of the software distribution platform 1505 periodically offer, transmit, and/or force updates to the software (e.g., the example computer readable instructions 1482 of FIG. 14B) to ensure improvements, patches, updates, etc. are distributed and applied to the software at the end user devices.

In the illustrated example of FIG. 15, the computer readable instructions 1482 are stored on storage devices of the software distribution platform 1505 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1482 stored in the software distribution platform 1505 are in a first format when transmitted to the example processor platform(s) 1500. In some examples, the first format is an executable binary in which particular types of the processor platform(s) 1500 can execute. However, in some examples, the first format is uncompiled code that requires one or more preparation tasks to transform the first format to a second format to enable execution on the example processor platform(s) 1500. For instance, the receiving processor platform(s) 1500 may need to compile the computer readable instructions 1482 in the first format to generate executable code in a second format that is capable of being executed on the processor platform(s) 1500. In still other examples, the first format is interpreted code that, upon reaching the processor platform(s) 1500, is interpreted by an interpreter to facilitate execution of instructions.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

### EXAMPLES

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a computing device, comprising: interface circuitry; and processing circuitry to: receive, via the interface circuitry, an encoded video stream, wherein the encoded video stream comprises video encoded in a plurality of layers at a plurality of resolutions, wherein the plurality of layers comprise a base layer and one or more enhancement layers, wherein the base layer encodes the video at a base resolution and the one or more enhancement layers encode the video at one or more enhanced resolutions higher than the base resolution; extract the base layer from the encoded video stream; decode the video at the base resolution from the base layer; detect content in the video based on analysis of the video at the base resolution; and generate metadata indicating the content detected in the video.

Example 2 includes the computing device of Example 1, wherein: the video is encoded at progressively higher resolutions across the plurality of layers; and at least some of the plurality of layers encode the video with a dependency on one or more other layers of the plurality of layers.

Example 3 includes the computing device of any of Examples 1-2, wherein the one or more enhancement layers comprise a full resolution layer, wherein the full resolution layer encodes the video at a full resolution.

Example 4 includes the computing device of Example 3, wherein the processing circuitry is further to: translate the metadata from the base resolution of the video to the full resolution of the video.

Example 5 includes the computing device of any of Examples 3-4, wherein the processing circuitry to detect the content in the video based on analysis of the video at the base resolution is further to: process the video through a video analytics pipeline, wherein the video is input into the video analytics pipeline at the base resolution, and wherein the video analytics pipeline performs a plurality of tasks to detect the content in the video.

Example 6 includes the computing device of Example 5, wherein the plurality of tasks comprise a content recognition task performed using an artificial neural network (ANN), wherein an input resolution of the ANN is: lower than the full resolution of the video; and equal to or lower than the base resolution of the video.

Example 7 includes the computing device of Example 6, wherein: the input resolution of the ANN is lower than the base resolution of the video; and the plurality of tasks further comprise a downscaling task to downscale the video from the base resolution to the input resolution of the ANN.

Example 8 includes the computing device of any of Examples 1-7, wherein the encoded video stream is a scalable coded video stream, wherein the scalable coded video stream is encoded based on: an H.264 video codec; an H.265 video codec; an MPEG-5 video codec; an AV1 video codec; or a VP9 video codec.

Example 9 includes the computing device of any of Examples 1-8, wherein: the processing circuitry comprises a host processor and a video analytics accelerator; the interface circuitry comprises an input/output (I/O) interconnect and a network interface controller; the host processor is to: receive, via the I/O interconnect or the network interface controller, the encoded video stream; extract the base layer from the encoded video stream; and send, via the I/O interconnect, the base layer to the video analytics accelerator; and the video analytics accelerator is to: receive, via the I/O interconnect, the base layer from the host processor; decode the video at the base resolution from the base layer; detect the content in the video based on analysis of the video at the base resolution; and generate the metadata indicating the content detected in the video.

Example 10 includes the computing device of Example 9, wherein the video analytics accelerator comprises: video decoder circuitry to decode the video at the base resolution from the base layer; and video analytics circuitry to detect the content in the video based on analysis of the video at the base resolution.

Example 11 includes at least one non-transitory machine-readable storage medium having instructions stored thereon, wherein the instructions, when executed on processing circuitry, cause the processing circuitry to: receive, via interface circuitry, an encoded video stream, wherein the encoded video stream comprises video encoded in a plurality of layers at a plurality of resolutions, wherein the plurality of layers comprise a base layer and one or more enhancement layers, wherein the base layer encodes the video at a base resolution and the one or more enhancement layers encode the video at one or more enhanced resolutions higher than the base resolution; extract the base layer from the encoded video stream; decode the video at the base resolution from the base layer; detect content in the video based on analysis of the video at the base resolution; and generate metadata indicating the content detected in the video.

Example 12 includes the storage medium of Example 11, wherein: the video is encoded at progressively higher resolutions across the plurality of layers; and at least some of the plurality of layers encode the video with a dependency on one or more other layers of the plurality of layers.

Example 13 includes the storage medium of any of Examples 11-12, wherein the one or more enhancement layers comprise a full resolution layer, wherein the full resolution layer encodes the video at a full resolution.

Example 14 includes the storage medium of Example 13, wherein the instructions further cause the processing circuitry to: translate the metadata from the base resolution of the video to the full resolution of the video.

Example 15 includes the storage medium of any of Examples 13-14, wherein the instructions that cause the processing circuitry to detect the content in the video based on analysis of the video at the base resolution further cause the processing circuitry to: process the video through a video analytics pipeline, wherein the video is input into the video analytics pipeline at the base resolution, and wherein the video analytics pipeline performs a plurality of tasks to detect the content in the video.

Example 16 includes the storage medium of Example 15, wherein the plurality of tasks comprise a content recognition task implemented using an artificial neural network (ANN), wherein an input resolution of the ANN is: lower than the full resolution of the video; and equal to or lower than the base resolution of the video.

Example 17 includes the storage medium of Example 16, wherein: the input resolution of the ANN is lower than the base resolution of the video; and the plurality of tasks further comprise a downscaling task to downscale the video from the base resolution to the input resolution of the ANN.

Example 18 includes the storage medium of any of Examples 11-17, wherein the encoded video stream is a scalable coded video stream, wherein the scalable coded video stream encodes the video at different video resolutions or frame rates across the plurality of layers.

Example 19 includes the storage medium of Example 18, wherein the scalable coded video stream is encoded based on: an H.264 video codec; an H.265 video codec; an MPEG-5 video codec; an AV1 video codec; or a VP9 video codec.

Example 20 includes the storage medium of any of Examples 11-19, wherein: the processing circuitry comprises a host processor and a video analytics accelerator; the interface circuitry comprises an input/output (I/O) interconnect and a network interface controller; the instructions cause the host processor to: receive, via the I/O interconnect or the network interface controller, the encoded video stream; extract the base layer from the encoded video stream; and send, via the I/O interconnect, the base layer to the video analytics accelerator; and the instructions cause the video analytics accelerator to: receive, via the I/O interconnect, the base layer from the host processor; decode the video at the base resolution from the base layer; detect the content in the video based on analysis of the video at the base resolution; and generate the metadata indicating the content detected in the video.

Example 21 includes a method, comprising: receiving, via interface circuitry, an encoded video stream, wherein the encoded video stream comprises video encoded in a plurality of layers at a plurality of resolutions, wherein the plurality of layers comprise a base layer and one or more enhancement layers, wherein the base layer encodes the video at a base resolution and the one or more enhancement layers encode the video at one or more enhanced resolutions higher than the base resolution; extracting the base layer from the encoded video stream; decoding the video at the base resolution from the base layer; detecting content in the video based on analysis of the video at the base resolution; and generating metadata indicating the content detected in the video.

Example 22 includes the method of Example 21, wherein detecting the content in the video based on analysis of the video at the base resolution comprises: detecting the content in the video using a convolutional neural network (CNN), wherein: the video is input into the CNN at the base resolution, wherein an input resolution of the CNN is equal to the base resolution; or the video is input into the CNN at the input resolution of the CNN, wherein the input resolution is lower than the base resolution, and wherein the video is downscaled from the base resolution to the input resolution.

Example 23 includes a computing system, comprising: an input/output (I/O) interconnect; a network interface controller (NIC); a host processor to: receive, via the I/O interconnect or the NIC, an encoded video stream, wherein the encoded video stream comprises video encoded in a plurality of layers at a plurality of resolutions, wherein the plurality of layers comprise a base layer and one or more enhancement layers, wherein the base layer encodes the video at a base resolution and the one or more enhancement layers encode the video at one or more enhanced resolutions higher than the base resolution; extract the base layer from the encoded video stream; and send, via the I/O interconnect, the base layer to a video analytics accelerator; and the video analytics accelerator to: receive, via the I/O interconnect, the base layer from the host processor; decode the video at the base resolution from the base layer; detect content in the video based on analysis of the video at the base resolution; and generate metadata indicating the content detected in the video.

Example 24 includes the computing system of Example 23, wherein: the host processor comprises a central processing unit (CPU); the video analytics accelerator comprises a vision processing unit (VPU); or the I/O interconnect comprises a peripheral component interconnect express (PCIe) interconnect.

Example 25 includes the computing system of any of Examples 23-24, wherein: the system further comprises a camera; and the host processor to receive, via the I/O interconnect or the NIC, the encoded video stream is further to: receive, via the I/O interconnect or the NIC, the encoded video stream from the camera.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A computing device, comprising:
interface circuitry; and
processing circuitry to:
receive, via the interface circuitry, an encoded video stream, wherein the encoded video stream comprises video encoded in a plurality of layers at a plurality of resolutions, wherein the plurality of layers comprise a base layer and one or more enhancement layers, wherein the base layer encodes the video at a base resolution and the one or more enhancement layers encode the video at one or more enhanced resolutions higher than the base resolution;
extract the base layer from the encoded video stream;
decode the video at the base resolution from the base layer;
detect content in the video based on analysis of the video at the base resolution; and
generate metadata indicating the content detected in the video.

2. The computing device of claim 1, wherein:
the video is encoded at progressively higher resolutions across the plurality of layers; and
at least some of the plurality of layers encode the video with a dependency on one or more other layers of the plurality of layers.

3. The computing device of claim 1, wherein the one or more enhancement layers comprise a full resolution layer, wherein the full resolution layer encodes the video at a full resolution.

4. The computing device of claim 3, wherein the processing circuitry is further to:
translate the metadata from the base resolution of the video to the full resolution of the video.

5. The computing device of claim 3, wherein the processing circuitry to detect the content in the video based on analysis of the video at the base resolution is further to:
process the video through a video analytics pipeline, wherein the video is input into the video analytics pipeline at the base resolution, and wherein the video analytics pipeline performs a plurality of tasks to detect the content in the video.

6. The computing device of claim 5, wherein the plurality of tasks comprise a content recognition task performed using an artificial neural network (ANN), wherein an input resolution of the ANN is:
lower than the full resolution of the video; and
equal to or lower than the base resolution of the video.

7. The computing device of claim 6, wherein:
the input resolution of the ANN is lower than the base resolution of the video; and
the plurality of tasks further comprise a downscaling task to downscale the video from the base resolution to the input resolution of the ANN.

8. The computing device of claim 1, wherein the encoded video stream is a scalable coded video stream, wherein the scalable coded video stream is encoded based on:
an H.264 video codec;
an H.265 video codec;
an MPEG-5 video codec;
an AV1 video codec; or
a VP9 video codec.

9. The computing device of claim 1, wherein:
the processing circuitry comprises a host processor and a video analytics accelerator;
the interface circuitry comprises an input/output (I/O) interconnect and a network interface controller;
the host processor is to:
receive, via the I/O interconnect or the network interface controller, the encoded video stream;
extract the base layer from the encoded video stream; and
send, via the I/O interconnect, the base layer to the video analytics accelerator; and
the video analytics accelerator is to:
receive, via the I/O interconnect, the base layer from the host processor;
decode the video at the base resolution from the base layer;
detect the content in the video based on analysis of the video at the base resolution; and
generate the metadata indicating the content detected in the video.

10. The computing device of claim 9, wherein the video analytics accelerator comprises:
video decoder circuitry to decode the video at the base resolution from the base layer; and
video analytics circuitry to detect the content in the video based on analysis of the video at the base resolution.

11. The computing device of claim 1, wherein the computing device is a smart camera or an edge appliance.

12. At least one non-transitory machine-readable storage medium having instructions stored thereon, wherein the instructions, when executed on processing circuitry, cause the processing circuitry to:
receive, via interface circuitry, an encoded video stream, wherein the encoded video stream comprises video encoded in a plurality of layers at a plurality of resolutions, wherein the plurality of layers comprise a base layer and one or more enhancement layers, wherein the base layer encodes the video at a base resolution and the one or more enhancement layers encode the video at one or more enhanced resolutions higher than the base resolution;
extract the base layer from the encoded video stream;
decode the video at the base resolution from the base layer;
detect content in the video based on analysis of the video at the base resolution; and
generate metadata indicating the content detected in the video.

13. The storage medium of claim 12, wherein:
the video is encoded at progressively higher resolutions across the plurality of layers; and
at least some of the plurality of layers encode the video with a dependency on one or more other layers of the plurality of layers.

14. The storage medium of claim 12, wherein the one or more enhancement layers comprise a full resolution layer, wherein the full resolution layer encodes the video at a full resolution.

15. The storage medium of claim 14, wherein the instructions further cause the processing circuitry to:
translate the metadata from the base resolution of the video to the full resolution of the video.

16. The storage medium of claim 14, wherein the instructions that cause the processing circuitry to detect the content in the video based on analysis of the video at the base resolution further cause the processing circuitry to:
process the video through a video analytics pipeline, wherein the video is input into the video analytics pipeline at the base resolution, and wherein the video analytics pipeline performs a plurality of tasks to detect the content in the video.

17. The storage medium of claim 16, wherein the plurality of tasks comprise a content recognition task implemented using an artificial neural network (ANN), wherein an input resolution of the ANN is:
lower than the full resolution of the video; and
equal to or lower than the base resolution of the video.

18. The storage medium of claim 17, wherein:
the input resolution of the ANN is lower than the base resolution of the video; and
the plurality of tasks further comprise a downscaling task to downscale the video from the base resolution to the input resolution of the ANN.

19. The storage medium of claim 12, wherein the encoded video stream is a scalable coded video stream, wherein the scalable coded video stream encodes the video at different video resolutions or frame rates across the plurality of layers.

20. The storage medium of claim 19, wherein the scalable coded video stream is encoded based on:
an H.264 video codec;
an H.265 video codec;
an MPEG-5 video codec;
an AV1 video codec; or
a VP9 video codec.

21. The storage medium of claim 12, wherein:
the processing circuitry comprises a host processor and a video analytics accelerator;
the interface circuitry comprises an input/output (I/O) interconnect and a network interface controller;
the instructions cause the host processor to:
receive, via the I/O interconnect or the network interface controller, the encoded video stream;
extract the base layer from the encoded video stream; and
send, via the I/O interconnect, the base layer to the video analytics accelerator; and
the instructions cause the video analytics accelerator to:
receive, via the I/O interconnect, the base layer from the host processor;
decode the video at the base resolution from the base layer;
detect the content in the video based on analysis of the video at the base resolution; and
generate the metadata indicating the content detected in the video.

22. A method, comprising:
receiving, via interface circuitry, an encoded video stream, wherein the encoded video stream comprises video encoded in a plurality of layers at a plurality of resolutions, wherein the plurality of layers comprise a base layer and one or more enhancement layers, wherein the base layer encodes the video at a base resolution and the one or more enhancement layers encode the video at one or more enhanced resolutions higher than the base resolution;
extracting the base layer from the encoded video stream;
decoding the video at the base resolution from the base layer;
detecting content in the video based on analysis of the video at the base resolution; and
generating metadata indicating the content detected in the video.

23. The method of claim 22, wherein detecting the content in the video based on analysis of the video at the base resolution comprises:
processing the video through a video analytics pipeline, wherein the video is input into the video analytics pipeline at the base resolution, and wherein the video analytics pipeline performs a plurality of tasks to detect the content in the video.

24. The method of claim 22, wherein detecting the content in the video based on analysis of the video at the base resolution comprises:
detecting the content in the video using a convolutional neural network (CNN), wherein:
the video is input into the CNN at the base resolution, wherein an input resolution of the CNN is equal to the base resolution; or
the video is input into the CNN at the input resolution of the CNN, wherein the input resolution is lower than the base resolution, and wherein the video is downscaled from the base resolution to the input resolution.

25. A computing system, comprising:
an input/output (I/O) interconnect;
a network interface controller (NIC);
a host processor to:
receive, via the I/O interconnect or the NIC, an encoded video stream, wherein the encoded video stream comprises video encoded in a plurality of layers at a plurality of resolutions, wherein the plurality of layers comprise a base layer and one or more enhancement layers, wherein the base layer encodes the video at a base resolution and the one or more enhancement layers encode the video at one or more enhanced resolutions higher than the base resolution;
extract the base layer from the encoded video stream; and
send, via the I/O interconnect, the base layer to a video analytics accelerator; and
the video analytics accelerator to:
receive, via the I/O interconnect, the base layer from the host processor;
decode the video at the base resolution from the base layer;
detect content in the video based on analysis of the video at the base resolution; and
generate metadata indicating the content detected in the video.

26. The computing system of claim 25, wherein:
the host processor comprises a central processing unit (CPU);
the video analytics accelerator comprises a vision processing unit (VPU); or
the I/O interconnect comprises a peripheral component interconnect express (PCIe) interconnect.

27. The computing system of claim 25, wherein:
the system further comprises a camera; and
the host processor to receive, via the I/O interconnect or the NIC, the encoded video stream is further to:
receive, via the I/O interconnect or the NIC, the encoded video stream from the camera.
